(19) United States
(12) Patent Application Publication
(10) Pub. No.: US 2026/0344932 A1
(43) Pub. Date: Nov. 5, 2026

(54) COOKING DEVICES AND COMPONENTS THEREOF

(71) Applicant: SharkNinja Operating LLC, Needham, MA (US)

(72) Inventors: Christopher Martin, North Attleboro, MA (US); Rebekah Mun-Fung Tsang, Brighton, MA (US); Roger Neil Jackson, Cornwall (GB); Kin Kit Christopher Wong, London (GB); Christopher Meyer-Rassow, London (GB); Matilda Swanson, London (GB); Coco DeFrancesco, Medford, MA (US); Jordan Ridgley, High Wycombe (GB); Toby Hale, Cheltenham (GB); Justin Shinn, Beaverton, MI (US); Zachary Veugen, Wareham, MA (US)

(21) Appl. No.: 19/326,222

(22) Filed: Sep. 11, 2025

Related U.S. Application Data
(63) Continuation of application No. 19/195,077, filed on Apr. 30, 2025.

(51) Int. Cl. A47J 37/06

(52) U.S. Cl. CPC A47J 37/0641

(57) ABSTRACT

Cooking systems, devices, and methods are provided that include a housing having a bottom surface suspended a distance above a countertop by a support attached to only one side of the housing, the bottom surface of the housing arranged to selectively couple to at least a first container, the housing having at least one heating element arranged to heat food within the first container, and at least one air movement device arranged to draw air into the housing and direct the air over the at least one heating element and into a volume of the first container.

### CROSS-REFERENCE TO RELATED APPLICATIONS

The present application is a continuation of U.S. patent application Ser. No. 19/195,077, filed Apr. 30, 2025, entitled “COOKING DEVICES AND COMPONENTS THEREOF,” which is hereby incorporated by reference in its entirety.

### FIELD

A countertop cooking system including one or more heating and air movement elements, a cooking chamber, and one or more thermal protection elements, are provided.

### BACKGROUND

An air fryer is a kitchen appliance that cooks by rapidly circulating hot air around food within a basket positioned in a cooking chamber. Some air fryers may come with adjustable temperature and timer knobs that allow for more precise cooking. Typically, heat is created by a heating coil and a mechanical fan circulates the hot air around the food at high speed. This cooking method produces a crispy layer on the food due to Maillard reactions. By creating and circulating heated air at temperatures, the air fryer is able to fry foods like potato chips, chicken, fish, pastries and more using much less oil than a traditional deep-fryer. Various brands of air fryers claim to use as much as 80% less cooking oil in comparison to traditional deep-fryers.

### SUMMARY

In one aspect, a cooking system is provided that includes a platform arranged to be positioned on a countertop and a housing coupled to the platform such that a bottom surface of the housing is suspended over the countertop, the bottom surface of the housing arranged to couple to a container. The housing includes a heating element arranged to heat food within the container, electronic components arranged to provide power to the cooking system, and at least one air movement device arranged to draw air into the housing, direct the air over the electronics components to provide convective cooling to the electronics components, and direct the air out of the bottom surface in a curtain around an exterior of at least a portion of a perimeter of the container to cool an external surface of the container.

In some aspects, the at least one air movement device may include: a first fan arranged to circulate a first flow of air within the container such that the first flow of air is directed over the heating element and into the container to heat food within the container, and a second fan arranged to draw a second flow of air into the housing and direct the second flow of air out of the bottom surface in the curtain around the exterior of at least the portion of a perimeter of the container.

In some aspects, the housing may further include a first portion extending upward from the bottom surface to a partition, and a second portion extending upward from the partition to a top of the housing, wherein the first fan is provided in the first portion, and wherein the electronics components and the second fan are provided in the second portion.

In some aspects, the housing may further include a first air intake extending from the top of the housing to a position above the first fan within the first portion, and a second air intake extending from the top of the housing into the second portion, wherein the second fan is arranged to draw air into the housing, via the second air intake, and direct the air over the electronics components and out of the bottom surface in the curtain around the exterior of at least the portion of a perimeter of the container.

In some aspects, the first fan may be arranged to draw air into the housing, via the first air intake, and direct the air over the heating element and into a volume of the container.

In another aspect, a cooking system is provided that includes a housing having a bottom surface arranged to couple to a container, the housing having a heating element arranged to heat food within the container, and at least one air movement device arranged to draw air into the housing and direct the air out of the bottom surface in a curtain around an exterior of at least a portion of a perimeter of the container to cool an external surface of the container.

In some aspects, the housing may further include an air intake provided at a top of the housing, wherein the at least one air movement device may be arranged to draw air into the housing, via the air intake.

In some aspects, the housing may further include an air outlet provided around at least a portion of a perimeter of the bottom surface, wherein the perimeter of the container is provided radially inward of the air outlet when the container is coupled to the bottom surface, and wherein the at least one air movement device may be arranged to direct the air out of the air outlet to cool the external surface of the container.

In some aspects, the air outlet may be provided above at least one handle provided on the external surface of the container such that the air directed out of the air outlet is arranged to cool the at least one handle.

In some aspects, the housing may further include electronic components positioned therein arranged to provide power to the cooking system, wherein the air drawn into the housing by the at least one air movement device may be arranged to provide convective cooling to the electronic components prior to being directed out of the bottom surface.

In some aspects, the at least one air movement device may include: a first fan arranged to draw a first flow of air into the housing and direct the first flow of air over the heating element and into the container to heat food within the container, and a second fan arranged to draw a second flow of air into the housing and direct the second flow of air out of the bottom surface in the curtain around the exterior of at least the portion of the perimeter of the container.

In some aspects, the housing may further include a first portion extending upward from the bottom surface to a partition, and a second portion extending upward from the partition to a top of the housing, wherein the first fan is provided in the first portion, and wherein the electronic components and the second fan are provided in the second portion.

In some aspects, the housing may further include a first air intake extending from the top of the housing to a position above the first fan within the first portion, and a second air intake extending from the top of the housing into the second portion, wherein the second fan may be arranged to draw air into the housing, via the second air intake, and direct the air over the electronic components and out of the bottom surface in the curtain around the exterior of at least the portion of the perimeter of the container.

In some aspects, the first fan may be arranged to draw air into the housing, via the first air intake, and direct the air over the heating element and into a volume of the container.

In another aspect, a cooking system is provided that includes a housing having a bottom surface arranged to couple to a container, a heating element arranged to heat food within the container, an air movement device, and an air intake extending from a top of the housing to a position above the air movement device, wherein the air movement device is arranged to draw air into the housing, via the air intake, and direct the air over the heating element and into a volume of the container.

In some aspects, the housing may further include a first portion extending upward from the bottom surface to a partition, and a second portion extending upward from the partition to the top of the housing, wherein the air movement device is provided in the first portion, and wherein the air intake extends from the top of the housing to the position above the air movement device within the first portion, bypassing the second portion.

In some aspects, the housing may further include an air exhaust extending from the first portion to the top of the housing, bypassing the second portion, wherein the air exhaust is arranged to draw air out of the first portion as the air intake brings air into the housing.

In some aspects, the cooking system may further include a second air movement device provided in the second portion, and a second air intake extending from the top of the housing into the second portion, wherein the air movement device is arranged to draw air into the housing, via the second air intake, and direct the air out of the bottom surface in a curtain around an exterior of at least a portion of a perimeter of the container to cool an external surface of the container.

In another aspect, a cooking system is provided that includes a platform arranged to be positioned on a countertop, a housing coupled to the platform such that a bottom surface of the housing is suspended over the countertop, the bottom surface of the housing including a seal assembly arranged to couple to a container, wherein the seal assembly includes at least one switch, and a heating element arranged to heat food within the container, wherein the seal assembly is arranged to move upward during initial coupling to the container, and wherein the seal assembly is arranged to move downward during final coupling to the container, prior to a cooking operation, to seal an upper perimeter of the container with the bottom surface thereby actuating the at least one switch.

In some aspects, the at least one switch may include a first switch and a second switch which both may be arranged to actuate when the container is coupled to the cooking system, the cooking system further including a controller arranged to determine a cooking mode based on the actuation of the first and second switches.

In another aspect, a cooking system is provided that includes a housing having a bottom surface including a seal assembly arranged to couple to a container, and a heating element arranged to heat food within the container, wherein the seal assembly is arranged to move upward during initial coupling to the container, and wherein the seal assembly is arranged to move downward during final coupling to the container, prior to a cooking operation, to seal an upper perimeter of the container with the bottom surface.

In some aspects, the seal assembly may be arranged to contact an entirety of an upper perimeter of the container during final coupling to the container.

In some aspects, the seal assembly may be arranged to extend past the upper perimeter of the container into a cooking volume of the container during final coupling to the container.

In some aspects, the housing may further include at least one air movement device and an air intake extending from a top of the housing to a position above the at least one air movement device, wherein the at least one air movement device is arranged to draw air into the housing, via the air intake, and direct the air over the heating element and into the container to heat food within the container.

In some aspects, the seal assembly may further include a first seal arranged to selectively couple to a first container, and a second seal arranged to selectively couple to a second container.

In some aspects, the cooking system may further include a controller, a first switch corresponding to the first seal, a second switch corresponding to the second seal, and a third switch corresponding to the seal assembly, wherein only the first and third switches are arranged to actuate when the first container is selectively coupled to the first seal, and only the second and third switches are arranged to actuate when the second container is selectively coupled to the second seal, and wherein the controller is arranged to determine a cooking mode based on the actuation of the first, second, and third switches.

In some aspects, the controller may be arranged to activate a first cooking mode responsive to actuation of the first switch and the third switch, and wherein the controller may be arranged to activate a second cooking mode responsive to actuation of the second switch and the third switch.

In some aspects, the heating element may be arranged to provide a first amount of heat in the first cooking mode and a second amount of heat in the second cooking mode.

In some aspects, the seal assembly may be arranged to move upward during initial coupling to the first container, and may be arranged to move downward during final coupling to the first container such that the first seal seals an upper perimeter of the first container with the bottom surface, and wherein the seal assembly arranged to move upward during initial coupling to the second container, and may be arranged to move downward during final coupling to the second container such that the second seal seals an upper perimeter of the second container with the bottom surface.

In another aspect, a cooking system is provided that includes a platform arranged to be positioned on a countertop, and a housing coupled to the platform such that a bottom surface of the housing is suspended over the countertop, the bottom surface of the housing including a seal assembly having a first seal arranged to selectively couple to a first container, and a second seal arranged to selectively couple to a second container that differs in size from the first container, the housing further including a heating element arranged to selectively heat food within one of the first container and the second container.

In some aspects, the cooking system may further include a controller, a first switch corresponding to the first seal, a second switch corresponding to the second seal, and a third switch corresponding to the seal assembly, wherein only the first and third switches are arranged to actuate when the first container is selectively coupled to the first seal, and only the second and third switches are arranged to actuate when the second container is selectively coupled to the second seal, and wherein the controller is arranged to determine a cooking mode based on the actuation of the first, second, and third switches.

In some aspects, the controller may be arranged to activate a first cooking mode responsive to actuation of the first switch and the third switch, and wherein the controller may be arranged to activate a second cooking mode responsive to actuation of the second switch and the third switch.

In some aspects, the heating element may be arranged to provide a first amount of heat in the first cooking mode and a second amount of heat in the second cooking mode.

In some aspects, the seal assembly may be arranged to move upward during initial coupling to the first container, and may be arranged to move downward during final coupling to the first container such that the first seal seals an upper perimeter of the first container with the bottom surface, and wherein the seal assembly arranged to move upward during initial coupling to the second container, and may be arranged to move downward during final coupling to the second container such that the second seal seals an upper perimeter of the second container with the bottom surface.

In some aspects, the first seal may be arranged to contact an entirety of an upper perimeter of the first container when the first seal is selectively coupled to the first container, and wherein the second seal is arranged to contact an entirety of an upper perimeter of the second container when the second seal is selectively coupled to the second container.

In some aspects, the first seal may be arranged to extend past an upper perimeter of the first container into a cooking volume of the first container when the first seal is selectively coupled to the first container, and wherein the second seal may be arranged to extend past an upper perimeter of the second container into a cooking volume of the second container when the second seal is selectively coupled to the second container.

In some aspects, the first and second seals may be each arranged to extend downward a different distance from the bottom surface.

In some aspects, the first seal may be concentric with the second seal.

In another aspect, a cooking system is provided that includes a platform arranged to be positioned on a countertop, the platform having a base and a spine projecting upward from the base, and a housing coupled to the spine such that a front of the housing is cantilevered over the base with a bottom surface of the housing being suspended over the countertop, the bottom surface of the housing arranged to couple to a container, the housing having a heating element arranged to heat food within the container, and at least one air movement device arranged to draw air into the housing and direct the air over the heating element and into a volume of the container.

In some aspects, a lateral width of the housing may be greater than a lateral width of the spine.

In some aspects, the cooking system may further include a container holder arranged to project from the spine below the bottom surface of the housing to support the container when it is coupled to the bottom surface, wherein the spine includes at least one angled slot positioned a first distance from the bottom surface of the housing, and the container holder includes a tab wherein the container holder is arranged to be removably coupled to the spine by inserting the tab into the at least one angled slot to form a cantilevered support.

In some aspects, the at least one angled slot may include a plurality of slots positioned at a plurality of distances from the bottom surface of the housing, wherein the container holder is arranged to be removably coupled to a slot of the plurality of slots based on a height of the container.

In another aspect, a cooking system is provided that includes a housing having a bottom surface suspended a distance above a countertop by a support attached to only one side of the housing, the bottom surface of the housing arranged to couple to a container, the housing having a heating element arranged to heat food within the container, and at least one air movement device arranged to draw air into the housing and direct the air over the heating element and into a volume of the container.

In some aspects, the support may be arranged to couple to a back of the housing, wherein a front of the housing is arranged to cantilever over the countertop.

In some aspects, a lateral width of the housing may be greater than a lateral width of the support. In some aspects, a lateral width of the support may be less than a lateral width of the container.

In some aspects, the support may include parallel bracing beams spaced laterally and arranged to extend into a platform arranged to be positioned on the countertop.

In some aspects, the support may be made from a material with a rigidity sufficient to withstand a force of 150 Newtons applied to the housing with no permanent deflection of the support. In some aspects, the support may be made from steel with a yield strength of at least 200 MPa.

In another aspect, a cooking system is provided that includes a housing having a bottom surface suspended above a countertop by a spine attached to only one side of the housing, the bottom surface of the housing arranged to couple to a container, the housing having a heating element arranged to heat food within the container, and at least one air movement device arranged to draw air into the housing and direct the air over the heating element and into a volume of the container, and a container holder arranged to project from the spine below the bottom surface of the housing to support the container when it is coupled to the bottom surface.

In some aspects, the spine may be arranged to couple a back of the base to a back of the housing, wherein a front of the housing is arranged to cantilever over the countertop.

In some aspects, a lateral width of the container holder may be less than a lateral width of the container.

In some aspects, the container holder may be arranged to restrict lateral movement of the container when the container is coupled to the bottom surface of the housing.

In some aspects, the spine may include at least one angled slot positioned a first distance from the bottom surface of the housing, and the container holder includes a tab wherein the container holder is arranged to be removably coupled to the spine by inserting the tab into the at least one angled slot to form a cantilevered support.

In some aspects, the at least one angled slot may include a plurality of slots positioned at a plurality of distances from the bottom surface of the housing, wherein the container holder is arranged to be removably coupled to a slot of the plurality of slots based on a height of the container.

In some aspects, the spine may include parallel bracing beams spaced laterally, wherein the at least one angled slot may be provided between the parallel bracing beams. In some aspects, the two parallel bracing beams may be arranged to extend into the platform and couple to a rigid partition of the housing.

In some aspects, the spine may be made from steel with a yield strength of at least 200 MPa.

In another aspect, a container arranged to selectively couple to a cooking system is provided, where the cooking system includes a housing with a bottom surface suspended above a countertop by a spine and a container holder arranged to project from the spine a distance below the bottom surface of the housing. The container includes a container body having an upper perimeter, sidewalls extending downward from the upper perimeter to a base to form a cavity arranged to receive a food product therein, and a thermal plate coupled to and extending downward from the base, wherein the height of the container from the upper perimeter to a bottom surface of the thermal plate matches the distance from the bottom surface of the housing to the container holder.

In some aspects, the container body may be made of glass.

In some aspects, the thermal plate may include handles for a user to hold when selectively coupling the container to the cooking system. In some aspects, the thermal plate may be made from a plastic material. In some aspects, the thermal plate may further include a plurality of feet protruding downward from the bottom surface of the thermal plate, wherein the feet may be arranged to be positioned laterally outside of the container holder when the container is selectively coupled to the cooking system such that lateral movement of the container is restricted.

In some aspects, the plurality of feet may include one or more first feet arranged to be positioned laterally outside of a first side of the container holder and one or more second feet arranged to be positioned laterally outside of a second side of the container holder opposite the first side. In some aspects, a lateral width between the one or more first feet and the one or more second feet may be between 85 mm and 100 mm.

In some aspects, the height of the container may be between 140 mm and 150 mm. In some aspects, the height of the container may be between 110 mm and 120 mm. In some aspects, the height of the container may be between 70 mm and 90 mm.

In another aspect, a cooking system is provided that includes a housing having a bottom surface arranged to couple to a container, the housing having a heating element arranged to heat food within the container, and at least one light provided within a front of the housing and insulated from the heating element, the at least one light being arranged to project light from the bottom surface at an angle oriented away from the front of the housing toward to a back of the container.

In some aspects, the at least one light may include a first light provided in a front right side of the housing and a second light provided in a front left side of the housing.

In some aspects, the at least one light may further include at least one halogen lamp provided within the housing and insulated from the heating element, and at least one light pipe coupled to the bottom surface of the housing and in optical communication with the at least one halogen lamp such that light from the at least one halogen lamp is arranged to illuminate the interior volume of the container via the at least one light pipe.

In some aspects, a bottom surface of the at least one light pipe can project a distance from the bottom surface of the housing that is greater than a distance that the heating element projects from the bottom surface of the housing.

In some aspects, the cooking system may further include a seal assembly provided on the bottom surface of the housing arranged to couple to the container, wherein the seal assembly is arranged to project a distance from the bottom surface of the housing that is greater than a distance that the at least one light pipe projects from the bottom surface of the housing.

In another aspect, a cooking system is provided that includes a housing having a bottom surface suspended a distance above a countertop by a support attached to only one side of the housing, the bottom surface of the housing arranged to selectively couple to at least one of a first container and a second container, the housing having at least one heating element arranged to heat food within the at least one of the first container and the second container, and at least one air movement device arranged to draw air into the housing and direct the air over the at least one heating element and into a volume of the at least one of the first container and the second container.

In some aspects, the at least one heating element may include a first heating element arranged to heat food within the first container and a second heating element arranged to heat food within the second container.

In some aspects, the at least one air movement device may include a first air movement device arranged to draw air into the housing and direct the air over the first heating element and a second air movement device arranged to draw air into the housing and direct the air over the second heating element.

In some aspects, the bottom surface of the housing may be arranged to selectively couple to both the first container and the second container to heat food within the first container and the second container simultaneously.

In some aspects, the first heating element and the first air movement device may be controlled independently of the second heating element and the second air movement device.

In some aspects, the bottom surface of the housing may include a seal assembly including a first seal arranged to selectively couple to the first container, and a second seal arranged to selectively couple to the second container, wherein the seal assembly is arranged to move upward during initial coupling to at least one of the first container and the second container, and wherein the seal assembly is arranged to move downward during final coupling to at least one of the first container and the second container to seal an upper perimeter of at least one of the first container and the second container with the bottom surface.

In some aspects, the housing may further include an air intake extending from a top of the housing to a position above the at least one air movement device, wherein the at least one air movement device is arranged to draw air into the housing, via the air intake, and direct the air over the at least one heating element and into at least one of the first container and the second container.

In some aspects, the cooking system may further include a controller, a first switch corresponding to the first seal, a second switch corresponding to the second seal, and a third switch corresponding to the seal assembly, wherein only the first and third switches are arranged to actuate when the first container is selectively coupled to the first seal, only the second and third switches are arranged to actuate when the second container is selectively coupled to the second seal, and the first, second and third switches are all arranged to actuate when both the first and second containers are selectively coupled to the first and second seals, respectively, wherein the controller is arranged to determine at least one cooking mode based on the actuation of the first, second, and third switches.

In some aspects, the controller may be arranged to activate a first cooking mode responsive to actuation of the first switch and the third switch, and wherein the controller may be arranged to activate a second cooking mode responsive to actuation of the second switch and the third switch.

In some aspects, the heating element may be arranged to provide a first amount of heat in the first cooking mode and a second amount of heat in the second cooking mode.

In some aspects, the first seal may be arranged to contact an entirety of an upper perimeter of the first container when the first seal is selectively coupled to the first container, and wherein the second seal may be arranged to contact an entirety of an upper perimeter of the second container when the second seal is selectively coupled to the second container.

In some aspects, the first seal may be arranged to extend past an upper perimeter of the first container into a cooking volume of the first container when the first seal is selectively coupled to the first container, and wherein the second seal may be arranged to extend past an upper perimeter of the second container into a cooking volume of the second container when the second seal is selectively coupled to the second container.

In some aspects, the first seal may be laterally spaced from the second seal along the bottom surface.

In another aspect, a cooking system is provided that includes a platform arranged to be positioned on a countertop, the platform having a base and at least one spine projecting upward from the base, and a housing coupled to the spine such that a front of the housing is cantilevered over the base with a bottom surface of the housing being suspended over the base, the bottom surface of the housing arranged to selectively couple to at least one of a first container and a second container, the housing having at least one heating element arranged to heat food within the at least one of the first container and the second container, and at least one air movement device arranged to draw air into the housing and direct the air over the at least one heating element and into a volume of the at least one of the first container and the second container.

In some aspects, the at least one spine may be arranged to couple a back of the base to a back of the housing, wherein a front of the housing is arranged to cantilever over the base.

In some aspects, a lateral width of the housing may be greater than a lateral width of the at least one spine.

In some aspects, the at least one spine may be a single spine having parallel bracing beams spaced laterally and arranged to extend into the platform. In some aspects, the at least one spine may include a first spine, and a second spine spaced laterally and arranged to extend into the platform.

In some aspects, the at least one spine may be made from a material with a rigidity sufficient to withstand a force of 150 Newtons applied to the housing with no permanent deflection of the at least one spine. In some aspects, the at least one spine may be made from steel with a yield strength of at least 200 MPa.

### DESCRIPTION OF DRAWINGS

These and other features will be more readily understood from the following detailed description taken in conjunction with the accompanying drawings, in which:

FIG. 1A is a perspective view of an aspect of a cooking device according to the subject matter described herein;

FIG. 1B is a front view of the cooking device of FIG. 1A with a cooking container attached;

FIG. 1C is a front view of the cooking device of FIG. 1A with the cooking container removed;

FIG. 1D is a side view of the cooking device of FIG. 1A;

FIG. 1E is a top view of the cooking device of FIG. 1A;

FIG. 1F is a cross-sectional view of the cooking device of FIG. 1A taken along section C-C of FIG. 1C;

FIG. 1G is an enlarged view of DETAIL-A of FIG. 1F;

FIG. 1H is a cross-sectional view of the cooking device of FIG. 1A taken along section D-D of FIG. 1C;

FIG. 1I is a cross-sectional view of the cooking device of FIG. 1A taken along section F-F of FIG. 1D;

FIG. 1J is a cross-sectional view of the cooking device of FIG. 1A taken along section E-E of FIG. 1C;

FIG. 1K is a cross-sectional view of the cooking device of FIG. 1A taken along section A-A of FIG. 1B;

FIG. 1L is an enlarged view of DETAIL-B of FIG. 1H, illustrating portions of one aspect of a seal assembly of the cooking devices according to the subject matter described herein;

FIGS. 1M-1N are detailed views of the portions of the aspect of the seal assembly of FIG. 1L depicting the seal assembly receiving a small or medium container and receiving a large container, respectively;

FIGS. 1O-1P are cross-sectional views of the cooking device of FIG. 1A taken along section G-G of FIG. 1E depicting the seal assembly with no container attached and the seal assembly with a container attached, respectively;

FIG. 1Q is a cross-sectional view of the cooking device of FIG. 1A taken along section B-B of FIG. 1B;

FIG. 1R is a cross-sectional view of the cooking device of FIG. 1A taken along section H-H of FIG. 1E;

FIGS. 2A-2B illustrate respective front and side views of another aspect of a cooking device according to the subject matter described herein;

FIGS. 3A-3B illustrate respective front and side views of another aspect of a cooking device according to the subject matter described herein;

FIGS. 4A-4B illustrate respective front and isometric views of one aspect of a cooking container according to the subject matter described herein;

FIG. 5 is a front view of another aspect of a cooking container according to the subject matter described herein;

FIG. 6 is a front view of another aspect of a cooking container according to the subject matter described herein;

FIG. 7 is a front view of another aspect of a cooking device according to the subject matter described herein;

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Traditional countertop cooking systems, such as air fryers, typically consist of a heating element and a fan positioned overtop of a cooking cavity of a fixed size that can only accommodate a singular sized cooking vessel. These conventional air fryers have a heating source and an air source located in the housing, above the cooking cavity, with both sources being supplied power for operation, typically by an AC power cord. These fryers also include a cooking basket provided with a handle which can be slidably secured within the cooking chamber to perform a cooking operation. However, due to the cooking basket being uniquely sized to fit in the cooking cavity, users often are required to remove food from any container in which it was previously stored and place the food into the cooking basket for cooking. Additionally, any food that not being consumed after cooking then has to be removed from the cooking basket and placed into a separate container for storage, which results in extra dishes having to be cleaned. Usually, the food basket is a large, heat conductive drawer that can accommodate a large volume of food. However, not all users require the large volume that traditional air fryers offer, if they are only cooking a small meal. Furthermore, these conventional air fryers can take up a lot of countertop space and can be clunky and aesthetically unappealing.

The present cooking devices disclosed herein look to combine both the cooking and storage aspect of a food product, while also allowing for versatility in the size of container that can be used for cooking. The cooking systems described herein are also much more sleek than conventional air fryers, providing a much more aesthetically modern look on a countertop. The present devices are compatible with a variety of different sized containers which can be utilized for both cooking of a food product, and storage of the food product. In order to achieve this efficiency, the variety of containers used are made from a thermal shock-resistant material such as borosilicate glass. Further, the food product placed in the containers for a cooking process can remain in the container after a cooking process without the need to be removed prior to storage. Instead of removing the food and cleaning the container, a user can use lids which are correspondingly sized to the openings on the containers, to seal the food product within the containers so that the containers can be easily transported.

The cooking systems described herein may comprise a cooking device and at least one vessel/container. The cooking devices (e.g., air fryers) may comprise a platform and a housing which includes at least one heating element and at least one air movement device. The platform can be positioned on a countertop and includes a base and a spine projecting upward from the base, the spine being arranged to couple to the housing such that a front of the housing is cantilevered over the base with a bottom surface of the housing being suspended over the countertop. A container of the cooking system can be selectively secured to the cooking system such that an opening of the container is sealed with the bottom surface of the housing. During a cooking operation, the at least one air movement device draws air into the housing and directs the air over the at least one heating element and into a volume of the container to heat food within the container. The heating element may be configured to convert electrical energy into thermal energy. For example, the cooking device may further comprise an electrical conduit (e.g., wire) that may be electrically connected to the heating element. The electrical conduit may also be configured to couple to a power source, such as a wall outlet. The air movement device(s) facilitate air flow around the heating element. For example, the air movement device(s) pull in relatively cool air from an external environment and push the air through one or more fluid conduits such that the air flows around the heating element. The heating element may transfer heat to the air such that the now-heated air may flow into the vessel. Accordingly, the air movement device(s) may facilitate convective heat transfer to any contents within the vessel.

Accordingly, embodiments of the cooking systems and methods described herein advantageously provide a system that can reheat and/or cook quickly using forced convection heat. Additional and/or alternative aspects of air frying technology are described in U.S. Pat. Nos. 11,619,394 and 11,490,761, and U.S. Patent Application Nos. 63/516,980, 63/616,182, 63/670,400, Ser. Nos. 18/883,692, 18/883,517, and 18/883,593, each of which are incorporated in their entirety by reference herein.

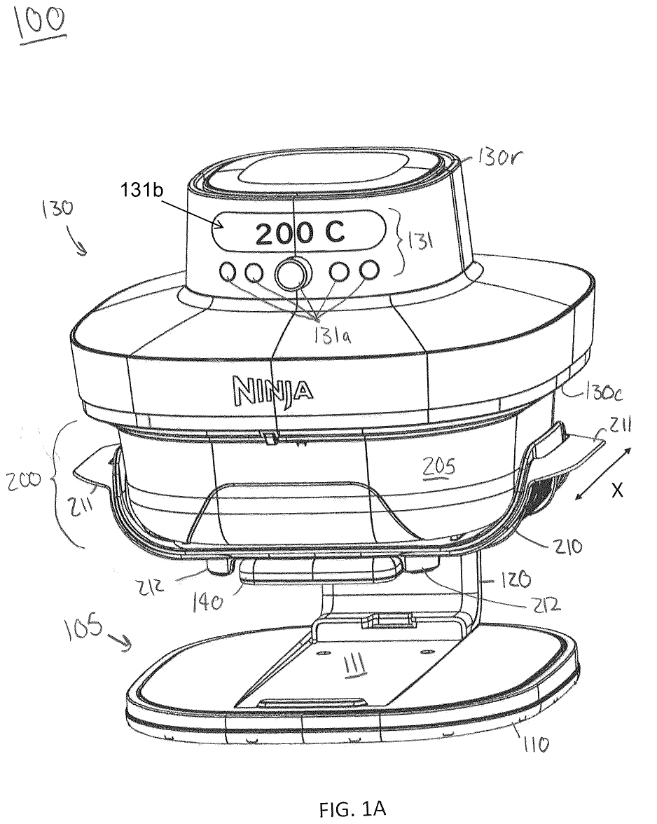

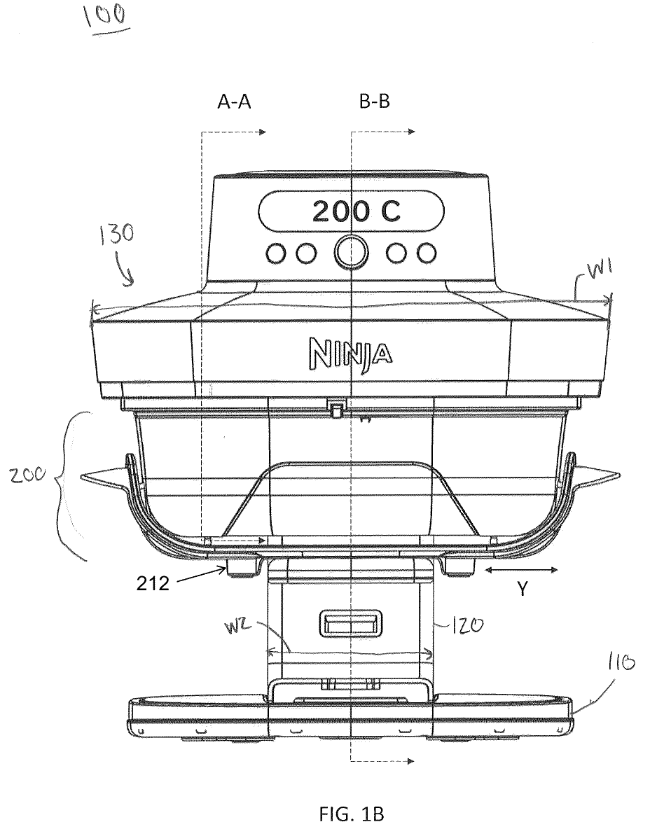

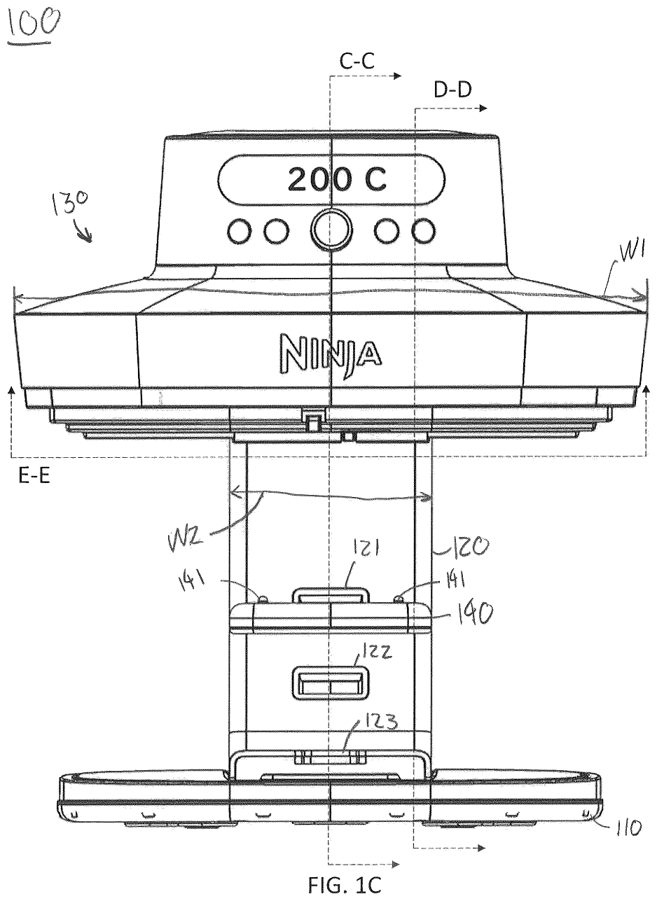

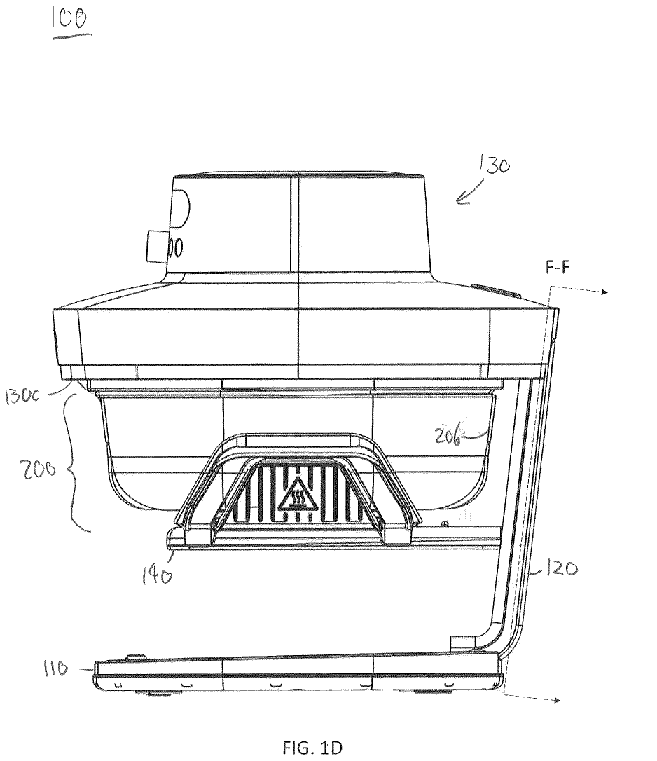

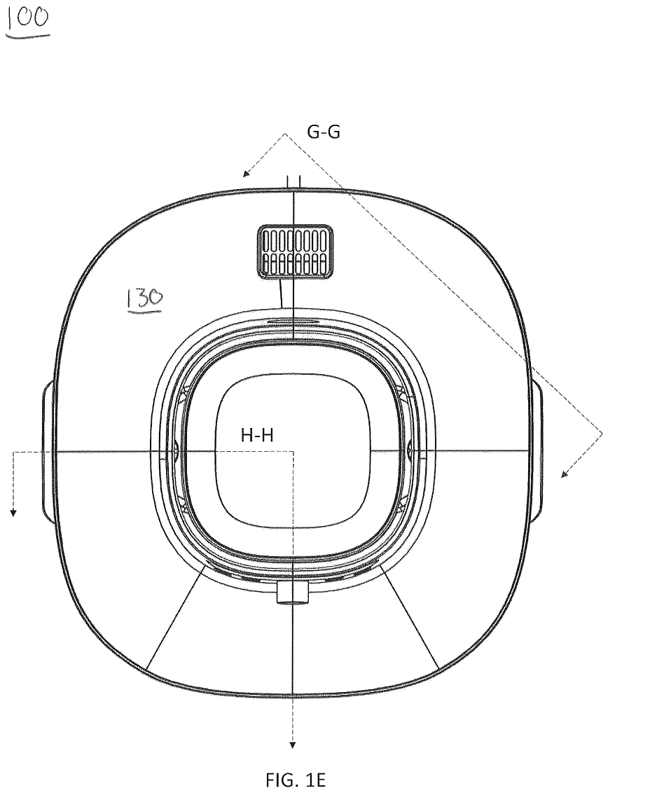

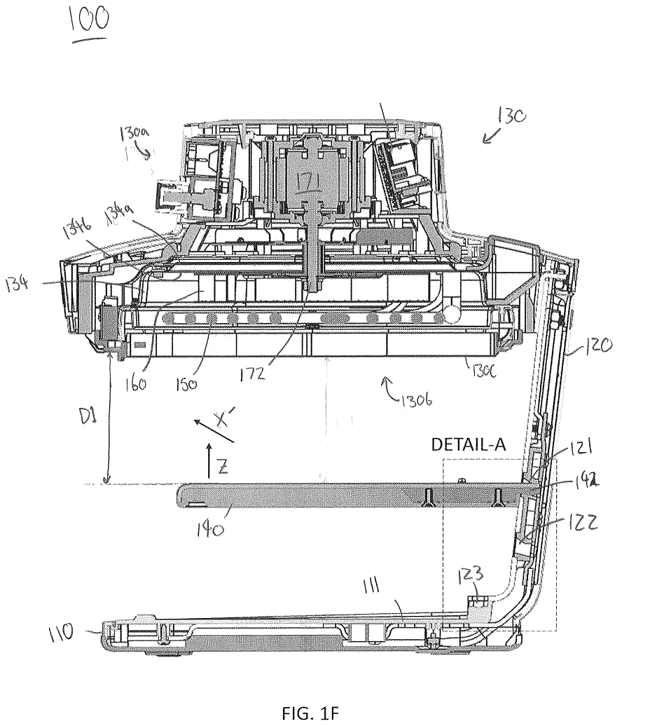

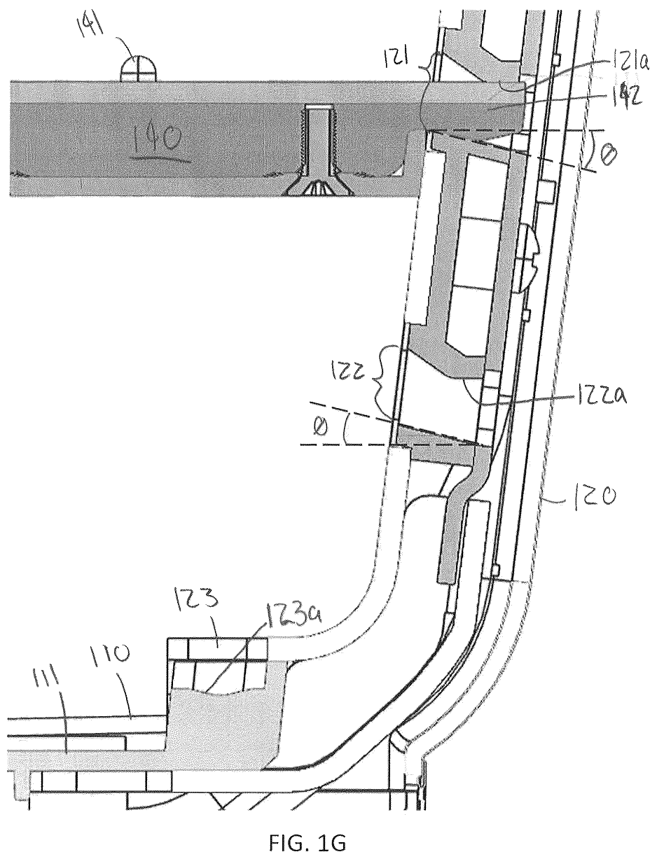

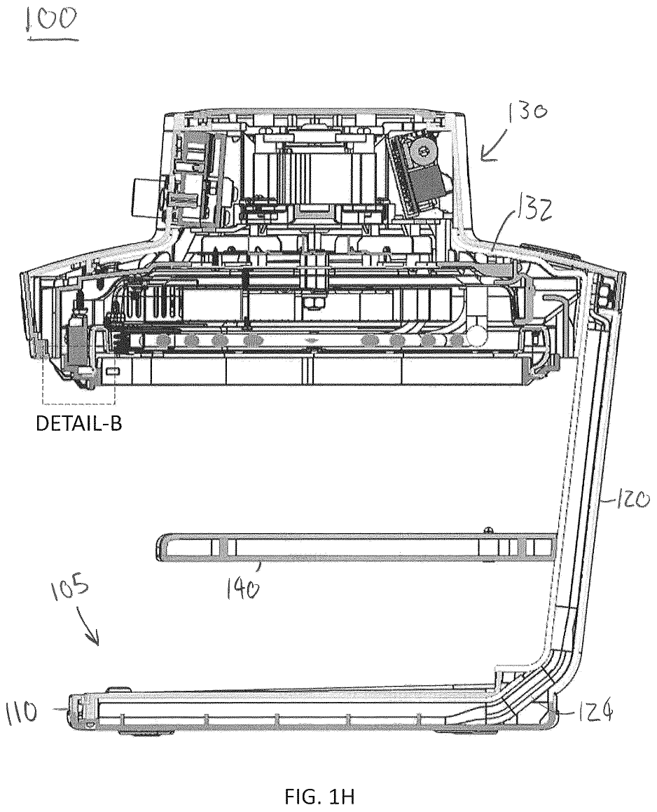

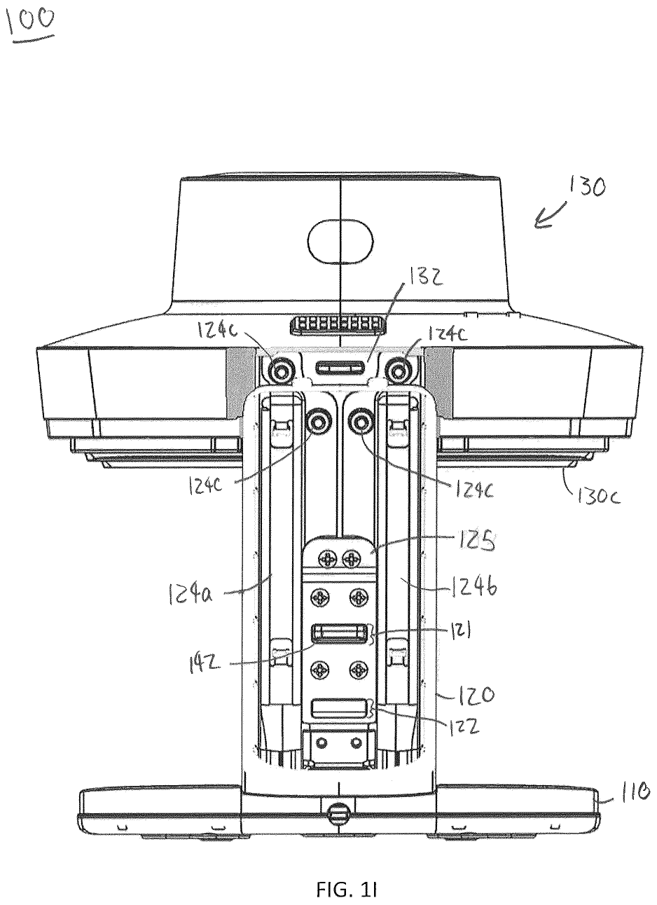

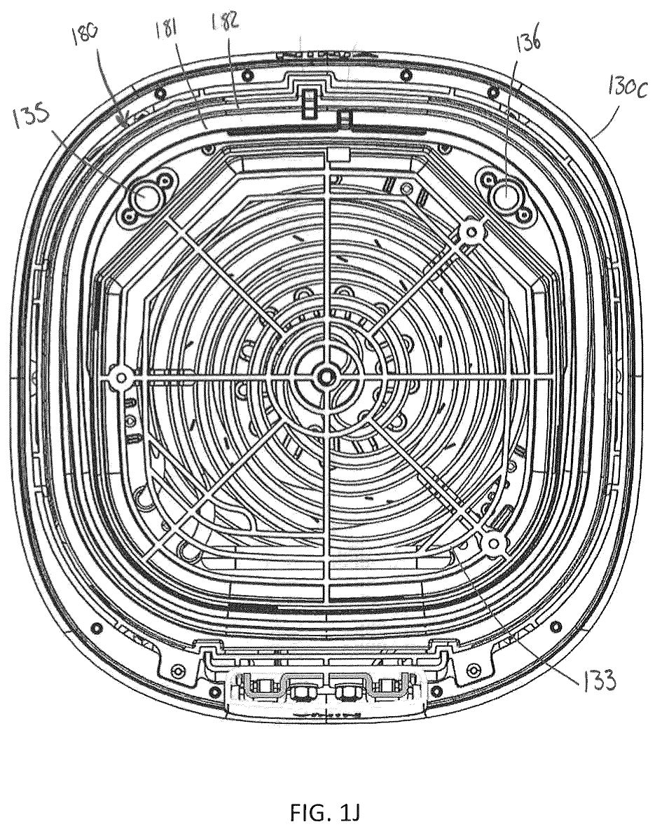

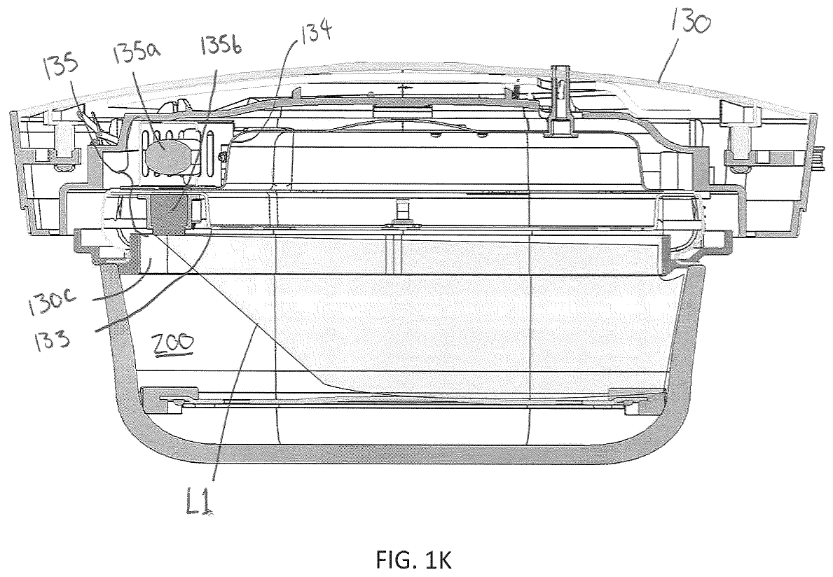

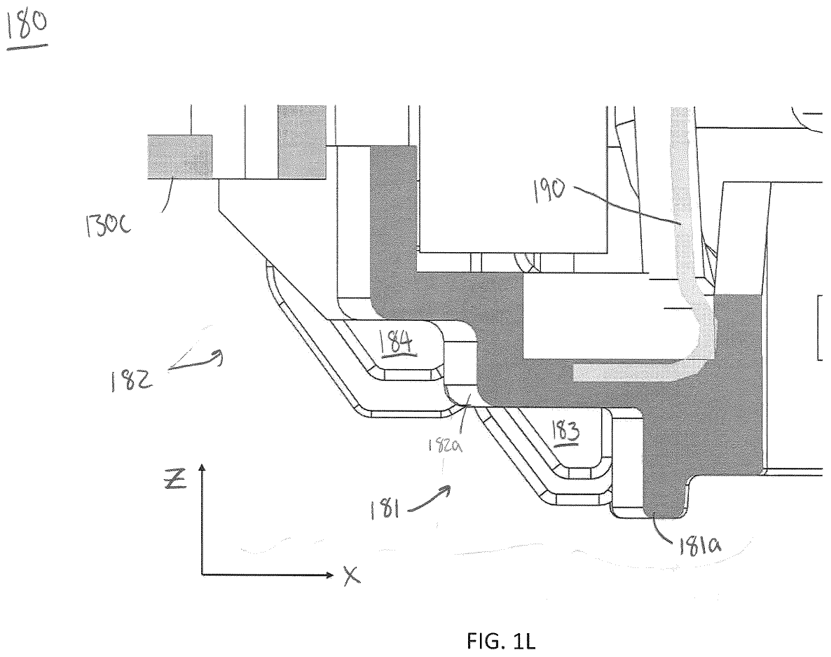

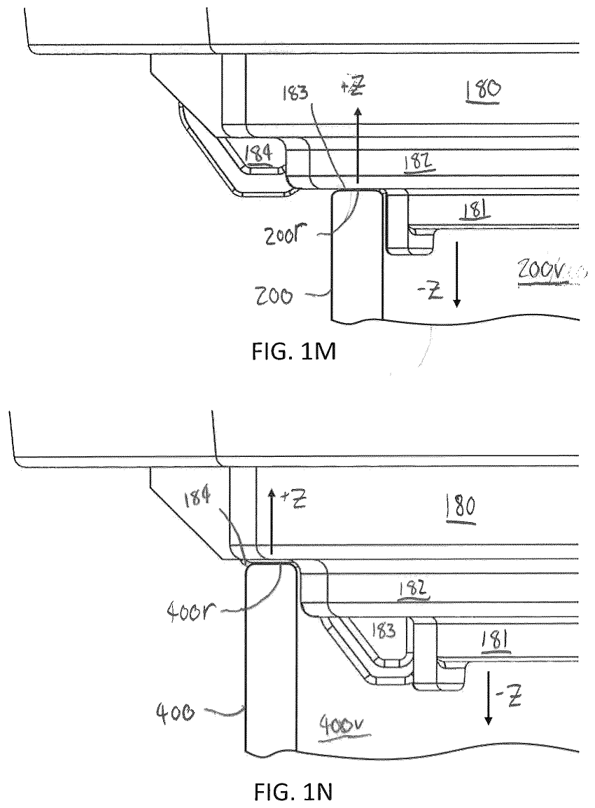

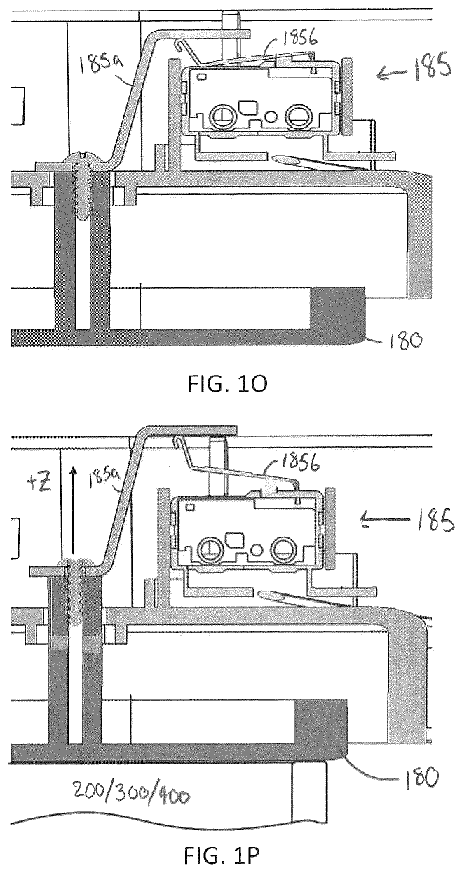

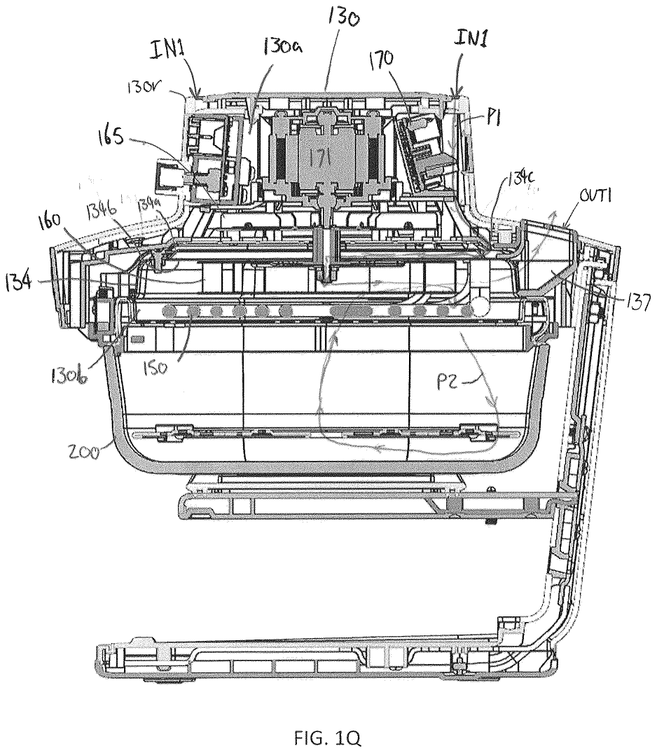

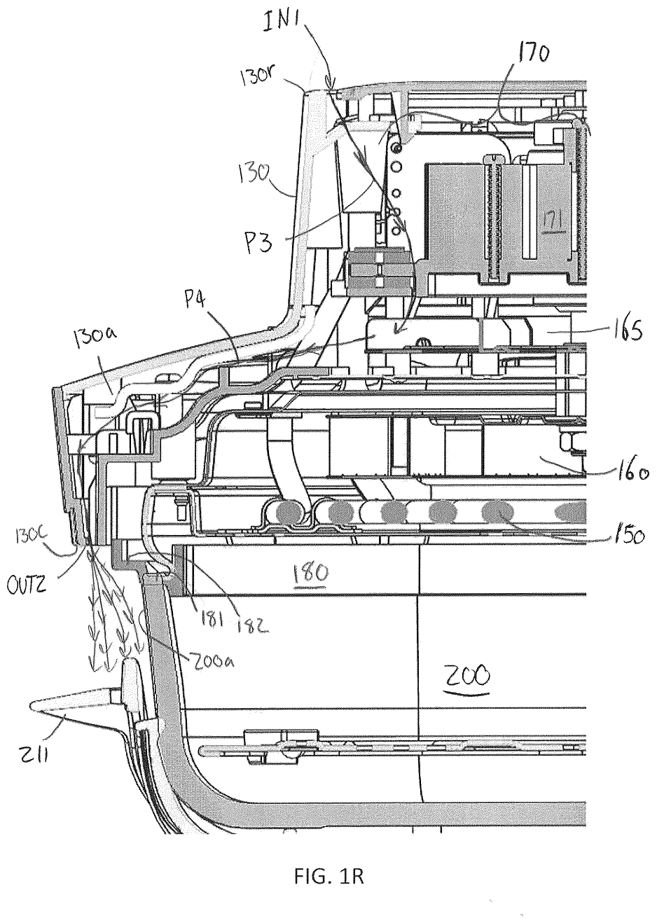

The overall structure and functionalities of the cooking systems described herein will be described in detail below, with reference made to FIGS. 1A-1R. FIG. 1A is an isometric view of one embodiment of a cooking system 100 according to the systems and methods described herein. As shown in FIG. 1A, the cooking system 100 includes a platform 105, a housing 130, a container holder 140 and at least one container 200. The housing 130 can be formed from a thermally nonconductive material, such as plastic. The housing 130 includes an input interface 131 on a top surface of the housing 130. The input interface 131 comprises a plurality of buttons/knobs 131a configured to allow a user to control the cooking device 100. The input interface 131 is connected to a control unit (not shown) arranged within the cooking device 100. For example, a user may control a power status (e.g., on, off), a cooking temperature, a power setting, a cooking mode (e.g., Airfry, Max Crisp, Reheat, etc.), a cooking time, or a combination thereof via the input interface 131. In some aspects, the input interface 131 can also include a digital screen 131b which can show a cooking temperature or other cooking information, and which can be illuminated by one or more lights (not shown) for user visibility. Additionally, in some aspects, a top rim 130r of the housing 130 can also be provided with a light strip (not shown) to provide additional aesthetic illuminating functionalities.

The platform 105 is arranged to be positioned on a countertop and includes a base 110 and a spine 120 projecting upward from the base 110 and coupling the housing 130 to the base 110. The base 110 also includes a cutout 111 for receiving the container holder 140 when a large sized container is being used. In some aspects, the base 110 and/or the spine 120 could also include a cooling fan (not shown), which can provide direct cooling to a base/side of the containers during cooking operations.

In some aspects, the container holder 140 can be selectively positioned at a variety of heights above the base 110 to accommodate a variety of container sizes, as discussed in greater detail below. Furthermore, the base 110 and/or the container holder 140 can be provided with weight sensors to both detect the presence of a container and to sense a weight of the container, which can be used by the controller, for example, to modify the cooking mode of the cooking operation. In some aspects, a top surface of the base 110 can be pitched at a slight angle from a front of the base 110 to a back of the base 110 such that the back of the base 110 is elevated a greater distance from the countertop that the front surface of the base. In this case, the cutout 111 can be parallel to the countertop such that the container holder 140 is horizontal when received in the cutout 111, as will also be discussed in greater detail below.

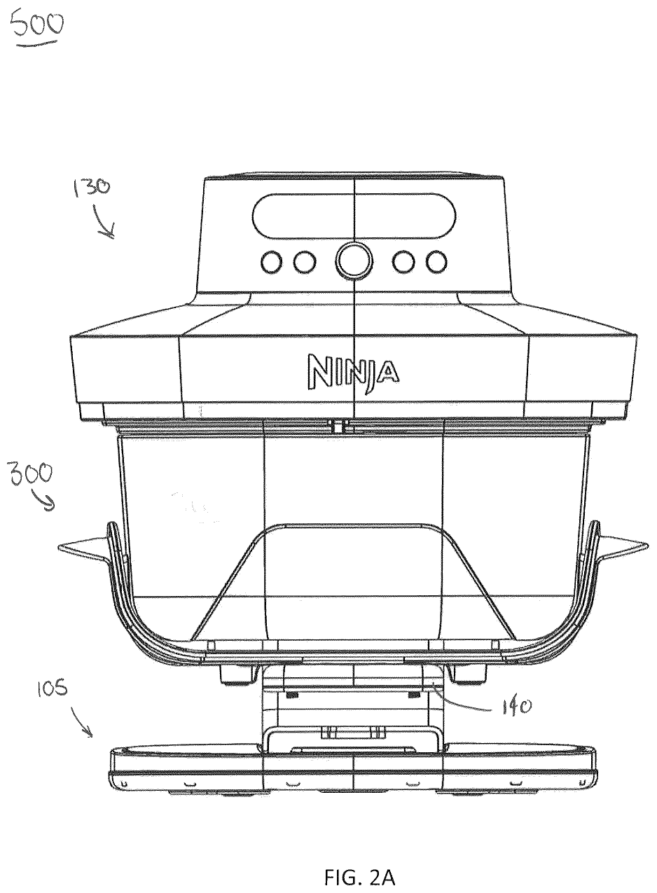

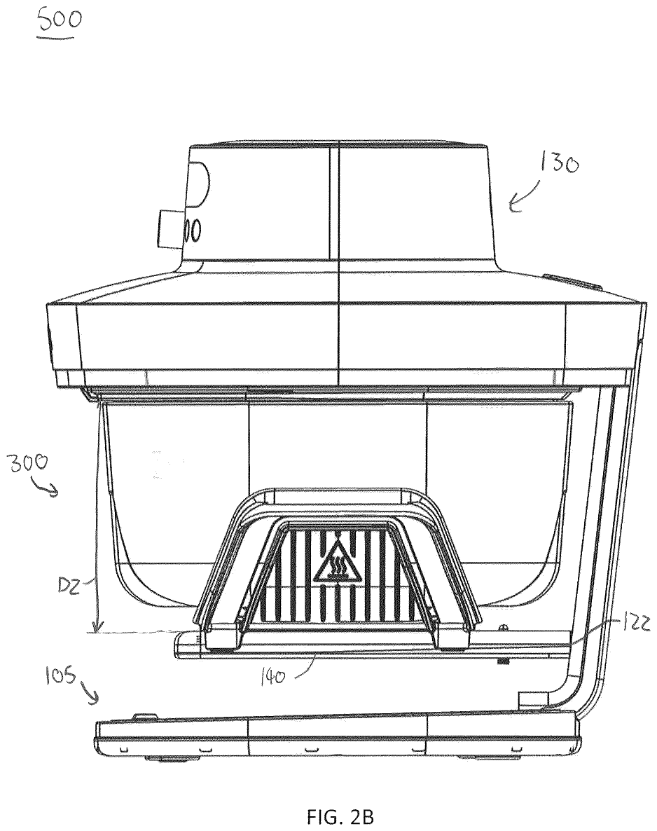

In some aspects, the at least one container 200 can include at least one of a small container 200. The cooking system 100 can also accommodate a medium container 300, and a large container 400, which are shown and described in greater detail below in reference to FIGS. 2A-6. The container 200 can be selectively coupled to the cooking system 100 by inserting the container 200 along a direction X such that the container 200 is securely positioned between the container holder 140 and a bottom surface 130c of the housing 130. Similarly, the container 200 can be selectively removed from the cooking system 100 by reversibly removing the container 200 along the direction X.

As shown in FIG. 1A, the container 200 can include a container body 205, and a container base 210 which includes handles 211 and feet 212, the details of which are described in greater detail below. By having the housing 130 only coupled to the platform 105 at a back of the housing by the spine 120, lateral sides of the container 200 are exposed when the container 200 is coupled to the cooking system. This advantageously allows for a user to grip the container with two hands, using the handles 211, to selectively couple/remove the container 200 from the cooking system 100, which can be beneficial in cases where the container 200, with food therein, is heavy.

As shown in FIG. 1B, when the container 200 is coupled to the cooking system 100, the feet 212 of the container base 210 can be positioned laterally outside of the container holder 140 such that movement of the container 200 in a lateral direction Y is restricted. As shown in FIG. 1C, a maximum lateral width W1 of the housing 130 is greater than a lateral width W2 of the spine 120. Additionally, the spine 120 is arranged to project upward from a back of the base 110 to couple the back of the base 110 to a back of the housing 130 such that the housing 130 is cantilevered over the base 110. This design provides the cooking system 100 with an aesthetically appealing look that creates the illusion that the housing 130 is floating over the countertop. Additionally, this design provides for a less clunky cooking system compared to conventional cooking systems. A front face of the spine 120 includes a plurality of angled slots 121, 122 and a base slot 123 which are each provided at different heights above the base 110. Each of the plurality of angled slots 121, 122 and the base slot 123 are arranged to selectively receive a tab of the container holder 140 to position the container holder at the different heights above the base 110 depending on a size of the container 200 being used for the cooking operation, as described in greater detail below. In some aspects, the plurality of angled slots 121, 122 can be substantially rectangular, however other shapes for the slots are also realized. For example, as shown in FIG. 1C, the container holder 140 is positioned in the angled slot 121 such that a top surface of the container holder 140 is positioned a first distance below a first seal provided on the bottom surface 130c of the housing 130 as discussed in greater detail below. In some aspects, a lateral width of the container holder can be substantially the same as the lateral width W2 of the spine 120 as shown, however it is also realized that the lateral width of the container holder 140 could be wider or narrower than the width W2 of the spine 120. In some aspects, as shown in FIG. 1C, the container holder 140 can further include one or more detent pins 141 which can protrude from a top surface of the container holder 140 and can be arranged to releasably engage with detents (e.g., recessed slots or holes) provided in the bases of any of the containers described herein to lock or index containers in place during cooking operations. In some cases, the detent pins 141 may be spring-loaded to allow for the pins to move out of the way of the containers as they are inserted into the cooking system 100 and then snap into releasable engagement with detents provided in the bases of any of the containers herein to lock the container in place. In some aspects, as shown in greater detail below, the detent pins 141 may only interact with a base of the large container 400 and may be unused during cooking operations with the small and medium containers 200/300.

FIG. 1D is a side view of the cooking system 100 of FIG. 1A with the container holder 140 and the container 200 attached. As shown in FIG. 1D, the spine 120 is arranged to project upward from a back of the base 110 to couple the back of the base 110 to a back of the housing 130 such that the housing is cantilevered over the base 110 with the top surface of the container holder 140 positioned the first distance below the seal provided on the bottom surface 130c of the housing 130 (distance D1 shown in FIG. 1F). In some aspects, the spine 120 can be arranged to project from the base at a slight angle from a vertical direction. Additionally, in some aspects, sidewalls 206 of the container body 205 can be pitched at an angle which corresponds to the angle at which the spine 120 projects from the base.

FIG. 1F is a cross-sectional view of the cooking device 100 taken along section C-C of FIG. 1C. As shown in FIG. 1F, the container holder 140 can include a tab 142 which is arranged to be securely positioned in the angled slot 121 such that the container holder 140 is cantilevered over the base 110 with the top surface of the container holder 140 positioned the first distance D1 below the first seal provided on the bottom surface 130c of the housing 130. The container holder 140 can be decoupled and recoupled from the spine 120 by reversibly lifting a cantilevered end of the container holder 140 in a direction Z and pulling the container holder 140 in a direction X′ such that the tab 142 can be removed from the angled slot 121. As shown in FIG. 1F, and as mentioned above in reference to FIG. 1A, the base 110 also includes a cutout 111 for receiving the container holder 140 when a large sized container is being used and the top surface of the base 110 can be pitched at a slight angle from a front of the base 110 to a back of the base 110 such that the back of the base 110 is elevated a greater distance from the countertop that the front surface of the base. In this case, the cutout 111 can be parallel to the countertop such that the container holder 140 is horizontal when received in the cutout 111.

FIG. 1G is an enlarged view of DETAIL-A of FIG. 1F. As shown in FIG. 1G, openings of each of the plurality of angled slots 121, 122 can be pitched at an angle Ø from horizontal and a bottom side of the tab 142 can be pitched at an angle reciprocal to the angle Ø. Each of the plurality of angled slots 121, 122 can also include a horizontal bearing surface 121a, 122a arranged to engage the top surface of the tab 142 when the tab 142 is inserted into the slots to provide direct resistance to the moment forces caused by the cantilevered container holder 140 to maintain a horizontal projection of the container holder 140 as it extends over the base 110. By providing the slots 121, 122 with the horizontal bearing surfaces 121a, 122a and the openings of the slots 121, 122 and the bottom side of the tab 142 with reciprocal angled pitches, the container holder 140 can be securely retained within the plurality of angled slots 121, 122 while maintaining a horizontal projection of the container holder 140 as it is cantilevered over the base 110. This design advantageously allows for the container(s) 200 of the cooking system 100 to be supported by the container holder 140 without the risk of the container holder 140 falling off the spine 120 when the container is removed from the cooking system 100. In other aspects, the tab/slot connection between the container holder 140 and the spine 120 can be more like a French cleat connection. As further shown in FIG. 1G, the top surface of the cutout 111 can be horizontal to the countertop and the base slot 123 can include a shelf surface 123a shaped corresponding to the bottom surface of the tab 142. The shelf surface 123a can be arranged to receive the bottom surface of the tab 142 when the container holder 140 is laid into the cutout 111. Accordingly, when the container holder 140 is laid into the cutout 111, the top surface of the container holder 140 is elevated from the top surface of the base 110. In case where a large container is being used with the system (e.g., container 400, as described below), feet of the large container can be positioned laterally outside of the container holder 140 such that movement of the large container in a lateral direction is restricted, similarly to as described above in reference to FIG. 1B. In other aspects, the container holder 140 can be omitted during a cooking operation using the large container 400 and the large container 400 can simply be received by the cooking system 100 between the base 110 and the bottom surface 130c of the housing 130. Additionally, in other aspects, rather than coupling to the spine 120, the container holder 140 can be a container platform having a greater height than that of the container holder 140 and can be arranged to slide into the cutout 111 without coupling to the spine 120 and to act as a platform to support either of the small or medium containers 200, 300.

FIG. 1H is a cross-sectional view of the cooking device 100 taken along section D-D of FIG. 1C. As shown in FIG. 1H, the spine 120 can also be provided with at least one bracing beam 124. In some aspects, the at least one bracing beam 124 can be provided laterally outside of the plurality of the plurality of slots 121, 122 and can be constructed from a material with a yield strength of 200 MPa. For example, in some aspects, the at least one beam 124 can be a uniform beam made from steel. As shown in FIG. 1H, the at least one beam 124 can follow the curvature of the platform 105, extending from the front end of the base 110 to that back end of the base 110, up the spine 120, and rigidly coupling to a structural plate 132 provided in the housing 130. In some aspects, the structural plate 132 can extend throughout the housing 130, acting as a structural frame and providing rigidity to the cantilevered housing 130. In some aspects, the structural plate 132 can be made from a material similar to the material of the at least one beam 124. It is also realized that the at least one beam 124 and the structural plate 132 could be formed as one uniform piece.

FIG. 1I is a cross-sectional view of the cooking device 100 taken along section F-F of FIG. 1D. As shown in FIG. 1I, in some aspects, the at least one beam 124 of the spine 120 can include a pair of parallel beams 124a, 124b. The pair of beams 124a, 124b can be rigidly coupled to the structural plate 132 via bolts 124c or via a welded connection, or any combination thereof. However, as mentioned above, it is also realized that the pair of beams 124a, 124b and the structural plate 132 could be formed as one uniform piece. Additionally, in some aspects, the structural beams can be coupled to the structural plate 132 via a hinged connection (not shown), or the like, which can allow for the entirety of the housing 130 to be pivoted upward relative to the base 110. This hinged design may be beneficial to make the base 110 and the bottom surface 130c of the housing more accessible to a user for in cleaning, or to allow the cooking system 100 to become thinner for storage purposes. In some aspects, as shown in FIG. 1I, the spine can also include a slot plate 125 mounted to the spine 120, laterally inside of the pair of parallel beams 124a, 124b, and arranged to provide rigidity to the plurality of slots 121, 122. For example, in some aspects, the horizontal bearing surfaces 121a, 122a of the plurality of slots 121, 122 can be formed in the structural plate 125. The pair of parallel beams 124a, 124b can be constructed from a material with a yield strength of 200 MPa in order to rigidly support the housing 130, similarly to as described above.

Turning to the housing 130, as illustrated in FIG. 1F, the housing 130 can be divided into an upper portion 130a and a lower portion 130b, which can be separated by a partition/radiation shield 134. As shown, the partition/radiation shield 134 can include two layers of material (upper layer 134a, and lower layer 134b) separated by an air gap to provide desirable insulative properties between the upper portion and the lower portion of the housing 130. The cooking system 100 also includes a heating element 150, a heating fan 160, a cooling fan 165, a temperature sensor (not shown), and electronics components (e.g., PCBA) 170 arranged to provide power to the heating element 150, heating fan 160, cooling fan 165, and temperature sensor. In some aspects, the cooling fan 165 and electronics components 170 can be arranged in the upper portion 130a of the housing 130 and the heating element 150 and the heating fan 160 can be arranged in the lower portion 130b of the housing, fully separated by the radiation shield 134. The electronics components 170 can include a controller arranged to control operations of the cooking system 100. The electronics components 170 can also provide power to the heating element 150 and can also include a motor 171 that powers the heating fan 160 and cooling fan 165. The motor 171, heating fan 160, and cooling fan 165 may together define an air movement device coupled together by a common axle 172, which is driven by the motor 171. The heating fan 160 can be a centrifugal fan or a stirrer fan which provides more efficient heat transfer during cooking operations. However, other commonly known fan types for the heating fan 160 are also realized. In some aspects, the temperature sensor can be a NTC or bimetallic temperature sensor which can shut off the heating element 150 in the event of overheating. In some aspects, the cooking system can further include a container temperature sensor (not shown), which can also be a NTC or bimetallic temperature sensor. In a case where a container temperature sensor is included in the cooking system 100, the container temperature sensor can be arranged to measure a temperature of the glass body of the container that is being used for the cooking operation and can communicate the temperature readings to the controller of the system. When the temperature of the glass rises above a predetermined threshold, the controller can be arranged to throttle the heating element 150 to allow for the glass of the container to cool.

The heating element 150 can be a radiative or convective heat source that, in combination with the heating fan 160, can produce a stream of heated air to cook food within the various containers described herein. For example, during a cooking operation, power from a power source can be provided to the electronics components 170 which can activate the heating element 150 and provide power to the air movement device causing a stream of air to be drawn into the housing 130 by the heating fan 160 and directed over the heating element 150 and into a cavity within the container to heat food disposed therein, as discussed in greater detail below. Additionally, as the heating fan 160 directs air over the heating element 150, the cooling fan 165 can simultaneously be arranged to direct a portion of the air drawn into the housing back up into the electronics components 170 to provide convective cooling to the electronics components, as discussed in greater detail below. In an aspect, the heating element 150 is a cal-rod, graphite, carbon fiber, or any other suitable heating source. In particular, the heating element 150 may convert electrical energy received into thermal energy, such that the heating element 150 increases in temperature. Furthermore, the heating fan 160 may rotate in either a clockwise or counterclockwise direction, such that air may move through, over, or otherwise around the heating element 150. The operation of the heating element 150 in combination with the heating fan 160 may correspond to a cooking process.

FIG. 1J is a cross-sectional view of the cooking device 100 taken along section E-E of FIG. 1C. As illustrated in FIG. 1J, the bottom surface 130c of the housing 130 can also be provided with a grill 133 which is arranged below the heating element 150. Additionally, as described above, the containers of the cooking systems described herein can be made from glass and can therefore be transparent. Accordingly, as shown in FIG. 1J, to allow for a user to better see the contents of the cooking container during a cooking operation, and to provide additional aesthetic value, the bottom surface 130c of the housing 130 can also be provided with at least one light 135, 136 arranged to illuminate a volume of the container during a cooking operation. In some aspects, a first light 135 can be provided in a front left side of the housing 130 and/or a second light 136 can be provided in a front right side of the housing 130. In other aspects, the systems described herein can include a single light provided centrally within the front of the housing 130, or a bar light provided across the front of the housing. This illuminating feature is shown, for example, in reference to FIG. 1K, which is a cross-sectional view of the cooking device 100 taken along section A-A of FIG. 1B. As shown in FIG. 1K, the light 135 can be provided within the front of the housing 130 and can be arranged to project light from the bottom surface 130c of the housing 130 at an angle oriented away from the front of the housing toward to a back of the container 200 (or a back of the containers 300 or 400 discussed below). The light 135 can include a halogen lamp 135a provided within the housing 130 and insulated from the heating element 150, and a light pipe 135b coupled to the bottom surface 130c of the housing 130 and in optical communication with the halogen lamp 135a. For example, in some aspects, the halogen lamp 135a can be provided in the upper portion 130a of the housing 130, above the partition/radiation shield 134 and the light pipe 135b can be provided in the lower portion 130b of the housing 130. In this case, the partition/radiation shield 134 can include an opening that allows for the light pipe 135b to be in optical communication with the halogen lamp 135a. During a cooking operation, the electronics components (e.g., electronics components 170) can provide power to the halogen lamp 135a such that light from the halogen lamp 135a is projected into the light pipe and directed at an angle from the front of the housing toward to a back of the container 200 to illuminate the interior volume of the container. In some aspects, the light pipe 135b can receded into the bottom surface 130c of the housing 130, as shown in FIG. 1K, such that only a small portion of the light pipe 135b extends past the grill 133 so as to not obstruct a cooking airflow during the cooking operation. The second light 136 can be substantially identical to the first light 135 and can operate similarly, accordingly, like components are not described herein. The lights 135, 136 can be programmed such that when the cooking system is initially powered on, the lights 135, 136 can be illuminated at a lower brightness (e.g., 50%). As the user begins to interact with the user interface 131, inputting cooking parameters, the lights 135, 136 can be controlled to increase their luminescence until the lights are illuminated at a higher brightness (e.g., 100%) for the cooking operation. Additionally, in some aspects, the cooking system 100 can be programmed with different light modes that allow for the lights 135, 136 to be variously illuminated in a theatrical fashion, to exhibit a sort of light show upon powering on the machine and/or during the cooking operation. In some aspects, the if the cooking system 100 also includes the light strip provided on the top rim 130r of the housing 130, as described above, the light strip can also be programmed to perform a similar sort of light show upon powering on the machine and/or during the cooking operation. In some aspects, any of the lights of the cooking systems described herein can further be programmed to change in intensity or color to indicate various cooking information to the user, like progress or temperature of a cooking operation or the like.

Conventionally, as described above, traditional air fryers typically consist of a cooking cavity of a fixed size that can only accommodate a singular, often large-sized cooking vessel. While these conventional large-sized cooking vessels can accommodate a lot of food, not all users require such a large volume, for example, in cases where they are only cooking a small meal. Additionally, the connection interface between the upper rim of the cooking basket and the cooking cavity of traditional air fryers typically has a tolerance gap which allows for the cooking basket to be easily inserted into the cooking cavity. However, one downside of this design is that hot air produced during a cooking operation can flow out of the gap between the upper rim of the cooking basket and the cooking cavity, causing heat loss which can result in inefficiencies of the cooking operation. The cooking systems and methods described herein have addressed the aforementioned shortcomings of traditional air fryers providing a dynamic seal assembly that is capable of accommodating and sealing around a variety of container sizes.

For example, looking back to FIG. 1J, the cooking system 100 can further include a seal assembly 180 which can be coupled to the bottom surface 130c of the housing 130. In some aspects, the seal assembly 180 can include a first seal 181 and a second seal 182. As shown in FIG. 1J, the first seal 181 can be arranged to seal around an upper rim of a small and/or medium container (e.g., containers 200 and 300) and the second seal 182 can be arranged to seal around a large container (e.g., container 400), as discussed in greater detail below. Accordingly, in some aspects, the first seal 181 and the second seal 182 can be concentric, with the second seal 182 being disposed radially outside of the first seal 181, as shown in FIG. 1J.

FIG. 1L is an enlarged view of DETAIL-B of FIG. 1H, showing a portion of the seal assembly 180. As shown in FIG. 1L, the first seal 181 and the second seal 182 can be concentric, with the second seal 182 being disposed radially outside of the first seal 181. Additionally, in some aspects, the first seal 181 can include an inner portion 181a that is arranged to protrude downward a first distance from the bottom surface 130c and the second seal 182 can include an inner portion 182a that is arranged to protrude downward a second distance from the bottom surface 130c, where the first distance is greater than the second distance. By providing the first and second seals with the aforementioned inner portions, the seals can advantageously project into a volume of the container which they are sealing around to better seal the container with the cooking system 100 during a cooking operation, as described below. The seal assembly 180 can also include a first sensor/switch 183 and/or a second sensor/switch 184 which are each arranged to detect when a container is received in the first seal 181 or the second seal 182, respectively. Additionally, in some aspects, the seal assembly can further include a deformable portion 190 which can allow for the seal to move up and down during container insertion and removal. The deformable portion 190 can be made from a heat-resistant rubber, or the like. In some aspects, the seal assembly 180 can also include one or more springs (not shown) provided within the housing 130 and arranged to bias the seal assembly 180 downward to ensure proper sealing around the container during the cooking operation.

For example, as a container is inserted into the cooking system 100 along the direction X, a leading edge of the rim of the container can be arranged to contact the seal assembly 180, causing the seal assembly 180 to move upward in the direction Z, which is permitted by deformable portion 190 and/or the springs provided in the housing. Once the container is properly seated in the cooking system (e.g., as shown in FIG. 1A), the springs of the seal assembly 180 can bias the seal assembly back downward in the Z direction to seal around the rim of the container. For example, FIG. 1M and 1N show detailed views of the portion of the seal assembly 180 shown in FIG. 1L, when the seal assembly 180 receives a small/medium container (e.g., container 200 or 300) or a large container (e.g., container 400). As shown in FIG. 1M, once the small container 200 (or medium container 300 described below) is received by the seal assembly 180, the seal assembly 180 is biased downward in the-Z direction such that the first seal 181 seals around a rim 200r of the container 200, with the inner portion 181a protruding into a cooking volume 200v of the container. Additionally, as the seal assembly 180 is biased downward, the first sensor/switch 183 contacts the rim 200r of the container and is actuated upward in the +Z direction. Depressing (e.g., applying a compressive force against) the first switch 183 may cause an electrical signal to change accordingly, which can be communicated to the controller of the system 100 to inform the system that the small container (or medium container 300) is present in the cooking system. Similarly, as shown in FIG. 1N, once the large container 400 is received by the seal assembly 180, the seal assembly 180 is biased downward such that the second seal 182 seals around a rim 400r of the container 400, with the inner portion 182a protruding into a cooking volume 400v of the container. By being able to dynamically move upward and downward, the seal assembly 180 described herein is advantageously capable of fully sealing around the rims of the containers described herein. This remedies the inefficiencies that are caused by the heat loss through the gap between the upper rim of the cooking basket and the cooking cavity of traditional air fryers. This design also allows for the cooking systems described herein to be accommodate and sealing around a variety of container sizes as described above.

As the seal assembly 180 is biased downward, the second sensor/switch 184 contacts the rim 400r of the container and is actuated upward. Depressing (e.g., applying a compressive force against) the second switch 184 may cause an electrical signal to change accordingly, which can be communicated to the controller of the system 100 to inform the system that the large container is present in the cooking system. In some aspects, for example, the seal assembly 180 can be provided with a 10 mm range of travel in the Z direction, to allow for the containers of the system to be easily positioned within the cooking system. However, larger or smaller travel distances for the seal assembly 180 are also realized. The controller may be arranged to determine a cooking mode for the cooking operation depending on whether the first switch 183 or the second switch 184 is actuated. For example, the small/medium containers of the system may be provided with a shallower cooking volume than the large container (discussed in greater detail below). In this case, a cooking operation with the small/medium containers may not require as much power/heat to achieve the same result as a cooking operation with the large container. Accordingly, by providing the seal assembly with the first and second switches 183, 184 corresponding to the first and second seals 181, 182, the controller of the system is advantageously able to determine which container is present within the system and automatically adjust the cooking mode or power setting of the cooking operation, or notify the user, via the interface 131, that a power increase/decrease is recommended based on the container size detected.

It is also realized that a user could accidentally actuate one of the first or second switches 183, 184 when no container is properly positioned within the cooking system 100. Accordingly, to avoid inadvertent cooking operations in this case, the seal assembly 180 can also be provided with a third sensor/switch 185, as shown in FIGS. 1O and 1P. FIGS. 1O and 1P are cross-sectional views of the cooking system 100 taken along section G-G of FIG. 1E. As shown in FIGS. 1O and 1P, the third switch 185 can include a lever arm 185a that is configured to bias a microswitch 185b into a first position, as shown in FIG. 1O when no container is present in the cooking system. The lever arm 185a is coupled to the seal assembly 180 such that when any container (e.g., any of containers 200, 300, 400 described herein) is properly positioned within the cooking system, the lever 185a is arranged to move upward in the Z direction with the seal assembly 180 to move the microswitch 185b into a second position, as shown in FIG. 1P. Accordingly, the controller of the system can be programmed to only allow for a cooking operation to be initiated if the third switch 185 is actuated, in addition to one of the first or second switches 183, 184. For example, upon determining, by the controller, that the first switch 183 and the third switch 185 have been actuated, the controller may activate a first cooking mode that is tuned specifically for a cooking operation with the small/medium container. Similarly, upon determining, by the controller, that the second switch 184 and the third switch 185 have been actuated, the controller may activate a second cooking mode that is tuned specifically for a cooking operation with the large container.

It is also realized that any of the sensors/switches 183-185 described above could be other sensor/switch types arranged to detect the presence of the containers described herein. For example, in some aspects, the sensors/switches 183-185 can include any of optical sensors, pressure sensors, infrared sensors, time-of-flight sensors, other electrical sensors, or combination thereof, which are capable of individually identifying the variety of containers described herein, as well as being able to confirm that the container is properly positioned within the cooking system.

As mentioned above, traditional air fryers typically have a gap between the upper rim of the cooking basket and the cooking cavity, which can be a point of heat loss. However, because traditional air fryers are not well sealed, they are able to draw air into the cooking cavity during cooking operations, through the gap between the basket and the cavity. By providing the improved sealing capabilities described above, the cooking systems described herein are not able to rely on this natural air seepage that is relied upon by traditional air fryers. Accordingly, the cooking systems described herein can further include a dedicated fresh air snorkel that is capable of bringing fresh air into the housing and directing the air into the cooking chamber for cooking. For example, FIG. 1Q is a cross-sectional view of the cooking system 100 taken along section B-B of FIG. 1B. As shown in FIG. 1Q, the top rim 130r of the housing 130 can be provided with an air inlet IN1. In some aspects, the air inlet IN1 can be provided around either an entirety of the top rim 130r, or only around a portion thereof. Additionally, or alternatively, in some aspects, the air inlet IN1 can also include one or more openings (e.g., small holes, slots, or other openings) provided on exterior sides of housing 130, arranged below the top rim 130r.

As described above, the housing 130 is arranged to house the heating element 150, the heating fan 160, the cooling fan 165, and the electronics components (e.g., PCBA) 170 arranged to provide power to the heating element 150, heating fan 160, cooling fan 165. The cooling fan 165 and electronics components 170 (including the motor 171) can be arranged in the upper portion 130a of the housing 130 and the heating element 150 and the heating fan 160 can be arranged in the lower portion 130b of the housing, fully separated by the radiation shield 134. During a cooking operation, the motor 171 is powered to drive the heating fan 160 and the cooling fan 165 (together defining the air movement device) in simultaneous rotation. Rotation of the air movement device can cause a pressure differential within the housing that causes air to be drawn into the housing via the air inlet IN1. As the air is drawn into the housing, a portion of the airflow can be directed along a snorkel flow path P1 provided within the housing 130. As shown in FIG. 1Q, the flow path P1 can be arranged to extend through a periphery of the upper portion 130a of the housing 130 until it reaches the upper layer 134a of the radiation shield 134. The flow path P1 can then extend through a first small opening 134c provided in the upper layer 134a of the radiation shield 134, proximate to the back of the housing 130, as shown. Once the airflow passes through the small opening 134c, the air flow path P1 can then extend horizontally within the gap between the upper layer 134a and the lower layer 134b until the air reaches a central point of the housing, substantially aligned with the axle 172. Adjacent to the axle 172, the lower layer 134b of the radiation shield can be provided with a second small opening (not shown), which can extend through the lower layer 134b into the lower portion 130b of the housing 130, directly overtop of the heating fan 160.

Accordingly, the air flow path P1 can direct the airflow through the second small opening provided in the lower layer 134b and expel the air directly over the heating fan 160 which can take in the air and direct the air over the heating element 150 to be heated. Once the air is heated by the heating element 150, the air can be arranged to follow a vortex flow path P2, whereby the air is directed downwards along sides of the container 200 until the air reaches the bottom of the container, at which point the air can be circulated back upward toward a central portion of the heating element, as shown in FIG. 1Q. In an aspect, the vortex flow path P2 is a torus shaped flow path. The vortex flow path P2 advantageously provides a heated airflow that circulates around both top and bottom surfaces of food within the container to provide thorough and even cooking of the food. Once the air is circulated back upward toward the central portion of the heating element, the heating fan 160 can then direct the air horizontally along the vortex flow path P2 until the air reaches an exhaust vent 137 provided at the back of the housing, as shown. It should be noted that, in some aspects, majority of the air that is heated by the heating element 150 and circulated along the vortex flow path P2 by the heating fan 160 is recirculated air that is originally present within the cooking volume of the cooking device 100, and only a small flow of air is drawn from the housing along flow path P1 into the cooking volume. The exhaust vent 137 is designed such that it bypasses the radiation shield 134 and the upper portion 130a of the housing 130, allowing for the air to be expelled along flow path P2 from the lower portion 130b directly to an outlet OUT1 of the exhaust vent 137. By providing the housing with the snorkel flow path P1 and the exhaust vent 137, the cooking system is able to fully seal the container with the seal assembly as described above and is still able to regulate the air that is drawn into the cooking system for the cooking operation. In some aspects, sizes of the first small opening 134c and the second small opening provided in the lower layer 134b of the radiation shield 134 can be specifically sized such that a ratio between air being drawn into the housing along the snorkel flow path P1 and air being exhausted out of the exhaust vent 137 establishes a desired level of humidity within the cooking volume of the container 200 during the cooking operation.

During operation, the electronics components (e.g., PCBA) 170 of the cooking system can produce heat as a result of powering the system. Accordingly, the cooling fan 165 can be provided to convectively cool the electronics components 170, using outside air, at the same time as the heating fan uses outside air to cook food in the container as described above. Additionally, in some cases, heat generated during cooking operations can be imparted onto the food container, causing the container to get hot to the touch, which can be a safety concern for users if the grab the container after the cooking operation. Accordingly, the systems and methods described herein may provide active cooling functionalities which are capable of actively cooling an exterior of the container during cooking, to ensure that the exterior of the container is not too hot if the user goes to grab the container during cooking of after cooking has completed.

For example, FIG. 1R is a cross-sectional view of the cooking device 100 taken along section H-H of FIG. 1E. As shown in FIG. 1R, and as described above, the top rim 130r of the housing 130 can be provided with the air inlet IN1. In some aspects, the air inlet IN1 can be provided around either an entirety of the top rim 130r, or only around a portion thereof. Similarly to as described above, during a cooking operation, the motor 171 is powered to drive the heating fan 160 and the cooling fan 165 (together defining the air movement device) in simultaneous rotation. Rotation of the air movement device can cause a pressure differential within the housing that causes air to be drawn into the housing via the air inlet IN1. As the air is drawn into the housing, a portion of the airflow can be directed along a cooling flow path P3 by the cooling fan 165. Specifically, as the cooling fan 165 rotates, it can draw air into the housing via the inlet IN1 and can direct a portion of the air along the flow path P3 to pass air by the electronics components (e.g., PCBA) 170 to convectively cool the electronics components 170 as they provide power to the cooking system 100.

Furthermore, while the air that is used to convectively cool the electronics components 170 may be warmer than the ambient air that is initially brought in through the inlet IN1, the air is still significantly cooler than the heat that can be affected to the exterior of the containers during cooking operations. Accordingly, it is also an aspect of the systems and methods described herein to leverage the air that is used to convectively cool the electronics components 170 to further cool the exterior of the containers of the system during cooking. Specifically, after the air flows over the electronics components 170 along flow path P3, the cooling fan 165 can be arranged to further direct the air along a secondary cooling flow path P4, as shown in FIG. 1R. The secondary cooling flow path P4 can begin at the cooling fan 165 and can extend along a periphery of the upper portion 130a of the housing until it reaches a sidewall of the housing, at which point the flow path P4 can extend downward to expel a flow of air out of an outlet OUT2, as shown. As shown in FIG. 1R, the outlet OUT2 can provided radially outward of the seal assembly 180 and the container 200. Accordingly, as air is directed along the flow path P4 by the cooling fan 165 and directed out of the outlet OUT2, the air can be projected downward to form an air curtain around the container, as shown, which is effective to convectively cool an external surface 200a of the container 200. In some aspects, the outlet OUT2 can be provided around an entire perimeter of the bottom surface 130c of the housing 130, however, in other aspects, the outlet OUT2 can only be provided on lateral sides of the bottom surface 130c to ensure that the handles 211 of the container 200 and a portion of the external surface 200a proximate to the handles 211 are effectively cooled. Because the outlet OUT2 is provided radially outside of both the first seal 181 and the second seal 182, the air curtain provided by the secondary cooling flow path P4 can effectively cool all container sizes that can be accommodated in the cooking system.

FIGS. 2A-2B show respective front and side views of a cooking system 500. As shown in FIGS. 2A-2B, the cooking system 500 includes the platform 105, the housing 130, the container holder 140 and the container 300. The platform 105, the housing 130, and the container holder 140 of the cooking system 500 can be similar to the cooking system 100 described above in reference to FIGS. 1A-1R, accordingly like components will not be described. Accordingly, prior to a cooking operation with the cooking system 500, the container holder 140 can be placed in the angled slot 122, as shown, to accommodate for the container 300.

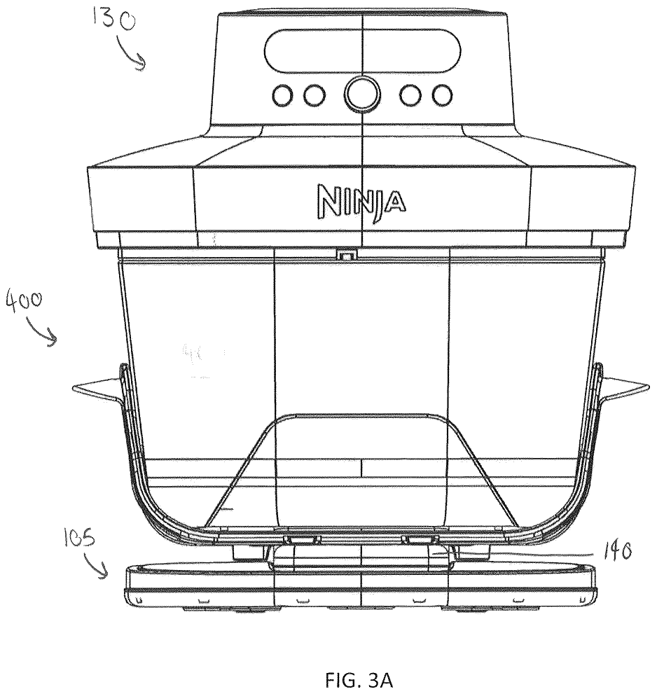

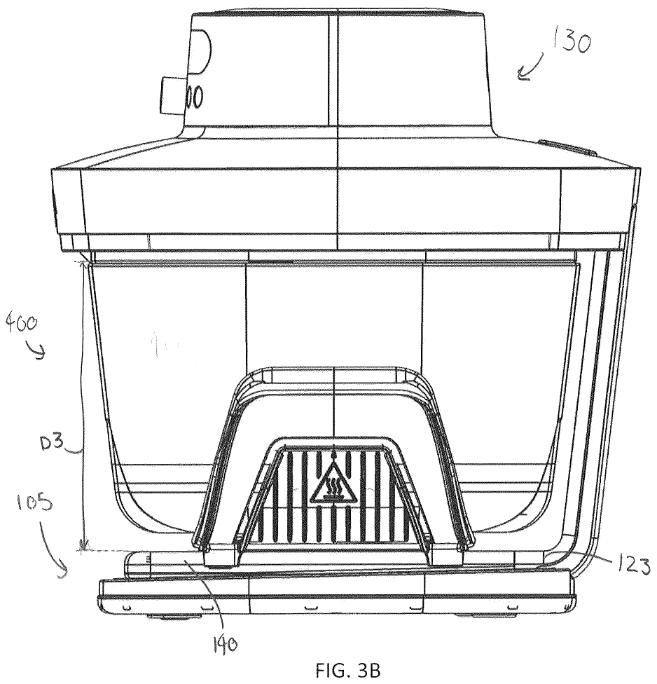

FIGS. 3A-3B show respective front and side views of a cooking system 600. As shown in FIGS. 3A-3B, the cooking system 600 includes the platform 105, the housing 130, the container holder 140 and the container 400. The platform 105, the housing 130, and the container holder 140 of the cooking system 600 can be similar to the cooking system 100 described above in reference to FIGS. 1A-1R, accordingly like components will not be described. Accordingly, prior to a cooking operation with the cooking system 600, the container holder 140 can be placed in the base slot 123, as shown, to accommodate for the container 400.

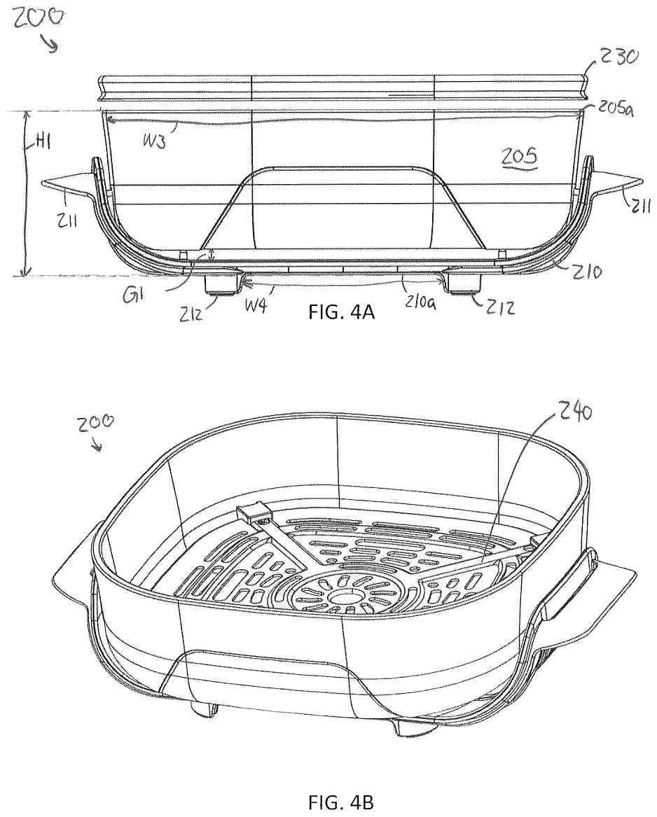

FIGS. 4A-4B show respective front and isometric views of the cooking container 200 described herein. As shown in FIG. 4A, the container 200 includes the container body 205, and the container base/thermal plate 210 which includes handles 211 and feet 212. As described above, container body 205 may be made from a thermal shock-resistant material such as borosilicate glass. In some aspects, the base/thermal plate 210 may be made from a plastic material. However, the materials of the container body 205 and/or base 210 may be selected based on one or more of thermal conductivity, density, expansion characteristics, compressive strength, tensile strength, and other material properties. The container body 205 and the base 210 can be fixed to one another via either a friction fitting or by using an adhesive. The container 200 can also be provided with an air gap G1 between the base of the container body 205 and the container base 210 which acts as a thermal barrier. In some aspects, the handles 211 may be configured to be handled by a user, such as to pick up or otherwise move the container 200. For example, the handles 211 may extend from outer surface of an upper portion of the base 210 on one or more sides of the container 200. In other aspects, the handles 211 may extend from outer surface of an upper portion of the base 210 and can form a single handle that wraps around an entirety of the container 200. A containment volume of the container 200 can be 2.5 quarts, however other sizes for the container are realized. The container 200 can also be provided with a lid 230 which can be removably coupled with the upper rim of the container so that the container can also be used for food storage. By providing the container with the lid 230, a user can simply keep any leftover food within the container 200 and cover the container 200 with lid 230 for direct storage, eliminating the need for transferring the food to a separate storage container.

A height H1 of the container 200, measured from a bottom surface 210a of the base 210 to an upper perimeter 205a of the container body 205 can be specifically designed to correspond to the first distance D1 between the top surface of the container holder 140 and the first seal 181 the bottom surface 130c of the housing 130, in reference to FIG. 1F, such that the container 200 and be securely positioned within the cooking system 100 when the container holder 140 is positioned in the slot 121. Specifically, in some aspects, the height H1 can be within a range of 70 mm-90 mm, particularly 79.5 mm, however, heights H1 which are greater than 90 mm or less than 70 mm are also realized. Additionally, a lateral width W3 of the upper perimeter 205a of the container body 205 can be specifically designed to match a width of the first seal 181 such that the upper perimeter 205a is fully sealed by the first seal 181 when the container 200 is secured to the cooking system. Furthermore, in some aspects, a lateral width W4 between the of the feet 212 can be specifically designed to correspond to the lateral width of the container holder 140, such that movement of the container 200 in the lateral direction is restricted when the container 200 is secured to the cooking system. For example, in some aspects, the lateral width W4 between the of the feet 212 can be within a range of 85 mm-100 mm, however, lateral widths W4 which are greater than 100 mm or less than 85 mm are also realized.

As shown in FIG. 4B, the container 200 can also be provided with one or more crisper trays 240 that may be slidably received by the container 200 cavity. The crisper tray 240 may be used to increase heat transfer to food contained within the container. The increase in heat transfer facilitated by the crisper tray may increase a temperature of the food within the vessel and thus increase a level of crispiness of an external surface of the food. Furthermore, the crisper tray may comprise one or more openings to facilitate fluid flow. For example, air may flow through the one or more openings to and/or from any food within the container, which may contribute to a crisping effect of the food.

FIG. 5 shows a front view of the cooking container 300 described herein. As shown in FIG. 5, the container 300 includes the container body 305, and the container base/thermal plate 310 which includes handles 311 and feet 312. The container 300 can be made from similar materials and can be constructed in a similar way to the container 200 described above, accordingly, like components are not described. A containment volume of the container 300 can be 4 quarts, however other sizes for the container are realized. The container 300 can also be provided with a lid 330 which can be removably coupled with the upper rim of the container so that the container can also be used for food storage. By providing the container with the lid 330, a user can simply keep any leftover food within the container 300 and cover the container 300 with lid 330 for direct storage, eliminating the need for transferring the food to a separate storage container.

A height H2 of the container 300, measured from a bottom surface 310a of the base 310 to an upper perimeter 305a of the container body 305 can be specifically designed to correspond to a second distance D2 between the top surface of the container holder 140 and the bottom surface 130c of the housing 130, in reference to FIG. 2B, such that the container 300 and be securely positioned within the cooking system 100 when the container holder 140 is positioned in the slot 122. Specifically, in some aspects, the height H2 can be within a range of 110 mm-120 mm, particularly 114 mm, however, heights H2 which are greater than 120 mm or less than 110 mm are also realized. Additionally, the upper perimeter 305a of the container body 305 can be specifically designed to have the same lateral width W3 as the container 200 to match a width of the first seal 181 such that the upper perimeter 305a is fully sealed by the first seal 181 when the container 300 is secured to the cooking system. Accordingly, the containers 200 and 300 can be designed with the same sized upper perimeters and can only differ in depth of the cooking volume defined in part by H1 and H2, respectively. Furthermore, in some aspects, the feet 312 can be specifically designed to have the same lateral separation W4 as the container 200 described above such that movement of the container 300 in the lateral direction is restricted when the container 300 is secured to the cooking system.

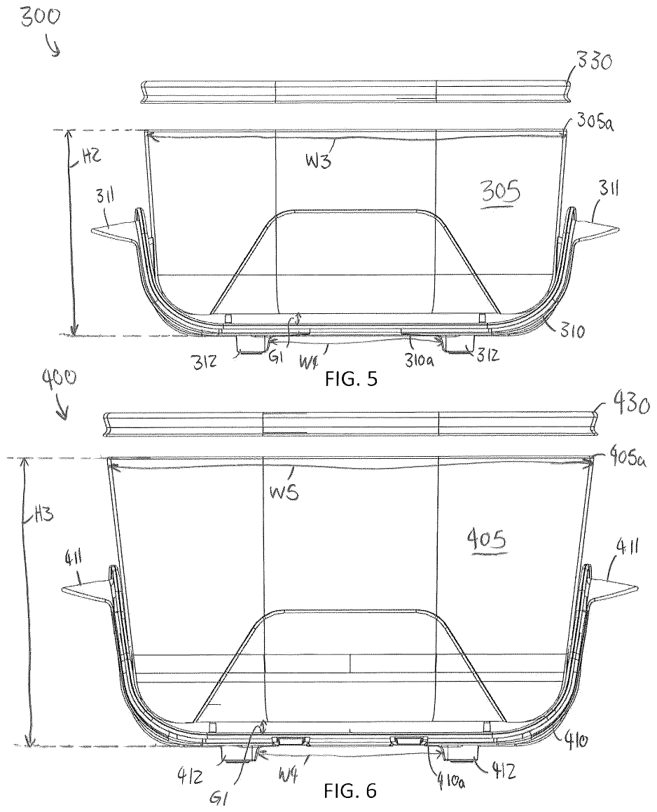

FIG. 6 shows a front view of the cooking container 400 described herein. As shown in FIG. 6, the container 400 includes the container body 405, and the container base/thermal plate 410 which includes handles 411 and feet 412. The container 400 can be made from similar materials and can be constructed in a similar way to the container 200 described above, accordingly, like components are not described. A containment volume of the container 400 can be 6 quarts, however other sizes for the container are realized. The container 400 can also be provided with a lid 430 which can be removably coupled with the upper rim of the container so that the container can also be used for food storage. By providing the container with the lid 430, a user can simply keep any leftover food within the container 400 and cover the container 400 with lid 430 for direct storage, eliminating the need for transferring the food to a separate storage container.

A height H3 of the container 400, measured from a bottom surface 410a of the base 410 to an upper perimeter 405a of the container body 405 can be specifically designed to correspond to a third distance D3 between the top surface of the container holder 140 and the bottom surface 130c of the housing 130, in reference to FIG. 3B, such that the container 400 and be securely positioned within the cooking system 100 when the container holder 140 is positioned in the base slot 123. Specifically, in some aspects, the height H3 can be within a range of 140 mm-150 mm, particularly 148.43 mm, however, heights H3 which are greater than 150 mm or less than 140 mm are also realized. Additionally, a lateral width W5 of the upper perimeter 405a of the container body 405 can be specifically designed to match a width of the second seal 182 such that the upper perimeter 405a is fully sealed by the second seal 182 when the container 400 is secured to the cooking system. Furthermore, in some aspects, the feet 412 can be specifically designed to have the same lateral separation W4 as the container 200 described above such that movement of the container 400 in the lateral direction is restricted when the container 400 is secured to the cooking system. In some aspects, the containers 300 and 400 can also be provided with one or more crisper trays which can be similar the crisper tray 240 of container 200 described above.

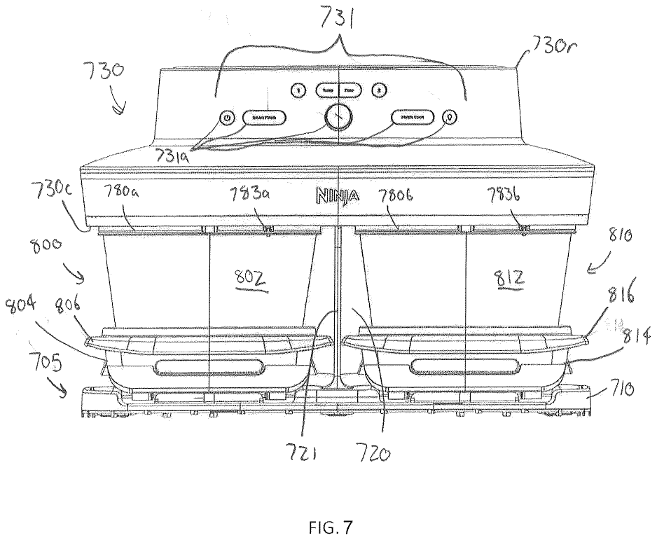

In some cases, users may wish to prepare a meal that includes multiple ingredients that have differing cooking requirements, e.g., chicken wings and brussels sprouts. Accordingly, in some aspects, the cooking systems described herein can be adapted to accommodate two cooking containers at a time, allowing for the user to execute simultaneous cooking operations using the same device. For example, FIG. 7 illustrates a front view of another cooking system 700 according to the systems and methods described herein. As shown in FIG. 7, the cooking system 700 can exhibit a similar construction to that of the cooking system 100 described above but can include two cooking cavities rather than a single cooking cavity.

As shown in FIG. 7, the cooking system 700 includes a platform 705, a housing 730, and at least two containers 800, 810. In some aspects, the cooking system 700 can also include additional containers (not shown), which can differ in height and/or width from the containers 800, 810, similarly to the size variability of the containers 200, 300, 400 described above. The platform 705 is arranged to be positioned on a countertop and includes a base 710 and a spine 720 projecting upward from the base 710 and coupling the housing 730 to the base 710. In some aspects, the base 710, spine 720 and housing 730 can have a similar construction to the base 110, spine 120 and housing 130 of cooking system 100 and can include similar components and functionalities, accordingly, like components are not described. Similar to the cooking system 100, a maximum lateral width of the housing 730 may be greater than a lateral width of the spine 720. Additionally, the spine 720 is arranged to project upward from a back of the base 710 to couple the back of the base 710 to a back of the housing 730 such that the housing 730 is cantilevered over the base 710. This design provides the cooking system 700 with an aesthetically appealing look that that deceives a user into thinking that the housing 730 is floating over the countertop. In some aspects however, to accommodate for the larger housing 730 of the cooking system 700, the spine 720 may be wider than the spine 120 of cooking system 100. In some aspects, the spine 720 also may include a structural fin 721 which is arranged to project forward from the spine 720 in between the containers 800, 810, to provide additional structural support for the housing 730.

Because the cooking system 700 is designed to accommodate two containers at a time, the housing 730 can include two independent sets of heating elements, heating fans, cooling fans and exhaust vents (not shown). In some aspects, each heating element, heating fan, and cooling fan of the cooking system 700 can be similar to the heating element 150, heating fan 160, cooling fan 165, and exhaust vent 137 of cooking system 100. Similar to housing 130, the housing 730 can be divided into an upper portion and a lower portion, which can be separated by a partition/radiation shield (not shown), which can include two layers of material separated by an air gap to provide desirable insulative properties between the upper portion and the lower portion of the housing 730. The cooking system 700 also includes temperature sensors (not shown), and electronics components (e.g., PCBAs) arranged to provide power to the heating elements, heating fans, cooling fans, and temperature sensors similarly to as described above. All the components within the housing 730 can be arranged in respective upper and lower portions of the housing 730 similarly to the arrangement of the components of system 100. The cooking system 700 can also be arranged to perform duplicative instances of the heating airflows and cooling air flows described above, during cooking operations using each of the containers 800, 810.

The housing 730 also includes an input interface 731 on a top surface of the housing 730. The input interface 731 comprises a plurality of buttons/knobs 731a configured to allow a user to control cooking operations for both containers 800, 810. The input interface 731 is connected to a control unit (not shown) arranged within the cooking device 700. A user may control a power status (e.g., on, off), a cooking temperature, a power setting, a cooking mode (e.g., Airfry, Max Crisp, Reheat, etc.), a cooking time, or a combination thereof via the input interface 731 for cooking operations for both containers 800, 810. In some aspects, the input interface 731 can include two sets of controls for controlling a cooking operation with each of the containers 800, 810 independently. In alternative aspects, the input interface 731 can include a single set of controls, which the user can toggle between a first configuration in which the user can control a cooking operation using the container 800, and a second configuration in which the user can control a cooking operation using the container 810. In some aspects, the input interface 731 can also include a digital screen which can show a cooking temperature or other cooking information, and which can be illuminated by one or more lights (not shown) for user visibility. Additionally, in some aspects, a top rim 730r of the housing 730 can also be provided with a light strip (not shown) to provide additional aesthetic illuminating functionalities, similarly to as described above.

As mentioned above, in some cases, users may wish to prepare a meal that includes multiple ingredients that have differing cooking requirements, e.g., chicken wings and brussels sprouts. Accordingly, in some aspects, the cooking system 700 can further include a functionality that allows the user to synchronize cooking operations using both the container 800 and the container 810 simultaneously. For example, expanding on the example provided above, the user can place the chicken wings (which require a cook time of 20 minutes at 300 degrees, for example) in container 800, and can place the brussels sprouts (which require a cook time of 10 minutes at 400 degrees, for example) in container 810. The user can then interact with the input interface 731 to set respective cooking parameters for the chicken wings and the brussels sprouts, based on the requirements provided above, and can then provide an input into the interface 731 requesting a synchronized cooking operation. Upon receipt of the synchronized cooking request, the controller can compare the cooking operations and can automatically initiate the cooking operations at different times, such that the two cooking operations complete at the same time. This functionality automatically ensures that no ingredient of the meal is left to sit and cool while waiting for other ingredients to finish cooking, providing the user with a uniformly hot meal at the concluding of the cooking operation. In other aspects, users may wish to prepare multiple meals in each container 800, 810 which require the same cooking parameters. In this case the system 700 can further include a mirroring functionality, which allows the user to interact with the input interface 731 to set cooking parameters one of the containers 800, 810 and then the system 700 can copy those cooking parameters and applying them to the other of the containers 800, 810 to eliminate duplicative user inputs. In some aspects, the user can also simply perform a cooking operation using a single container 800 or 810.

The containers 800, 810 can be selectively coupled to the cooking system 700 by inserting the containers 800, 810 into a front of the housing 730, such that the containers 800, 810 are securely positioned between the base 710 and a bottom surface 730c of the housing 730, similarly to as described above. Accordingly, the system 700 can further include independent seal assemblies 780a, 780b, which can be coupled to the bottom surface 730c of the housing 730. In some aspects, each seal assembly 780a, 780b can be similar to the seal assembly 180 of cooking system 100 described above and can include one or seals and sensors/switches 783a, 783b, which can operate as described above to seal the containers 800, 810, respectively, during cooking operations.

In some aspects, the containers 800, 810 can each include a container body 802, 812, and a container base 804, 814 which includes handles 806, 816. In some aspects, the materials of the containers 800, 810 and the dimensional design requirements can be similar to those of containers 200, 300, and 400 described above, such that the containers fit within the cooking system 700 in much the same way as the containers 200, 300, and 400 fit within the cooking systems 100, 500, and 600. Additionally, in some aspects, the handles of the containers described herein (e.g., handles 211, 311, 411, 806, 816) may be provided on the bases of the containers with a hinged connection or the like such that the handles can be folded to better fit within the cooking systems described herein or for storage. For example, in some aspects, the handles 806, 816 of containers 800, 810 can be provided with a folding means to allow for the two containers to better fit within the housing.

Certain aspects have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

1.-20. (canceled)

21. A cooking system, comprising:
a platform configured to be positioned on a countertop; and
a housing coupled to the platform such that a bottom surface of the housing is suspended over the countertop, the bottom surface of the housing configured to couple to a container, the housing comprising:
a heating element configured to heat food within the container;
at least one electronic component configured to provide power to the cooking system; and
at least one air movement device configured to draw air into the housing, direct the air over the at least one electronic component to provide convective cooling to the electronic component, and direct the air out of the bottom surface around an exterior of at least a portion of a perimeter of the container to cool an external surface of the container.

22. The cooking system of claim 21, wherein the at least one air movement device comprises:
a first fan configured to circulate a first flow of air within the container such that the first flow of air is directed over the heating element and into the container to heat food within the container; and
a second fan configured to draw a second flow of air into the housing and direct the second flow of air out of the bottom surface around the exterior of at least the portion of a perimeter of the container.

23. The cooking system of claim 22, wherein the housing further comprises a first portion extending upward from the bottom surface to a partition, and a second portion extending upward from the partition to a top of the housing, wherein the first fan is provided in the first portion, and wherein the electronics components and the second fan are provided in the second portion.

24. The cooking system of claim 23, wherein the housing further comprises a first air intake extending from the top of the housing to a position above the first fan within the first portion, and a second air intake extending from the top of the housing into the second portion, wherein the second fan is configured to draw air into the housing, via the second air intake, and direct the air over the electronics components and out of the bottom surface around the exterior of at least the portion of a perimeter of the container.

25. The cooking system of claim 24, wherein the first fan is configured to draw air into the housing, via the first air intake, and direct the air over the heating element and into a volume of the container.

26. A cooking system, comprising:
a platform configured to be positioned on a countertop, the platform having a base;
a spine projecting upward from the base; and
a housing coupled to the spine such that a front of the housing is cantilevered over the base with a bottom surface of the housing being suspended over the countertop, the bottom surface of the housing configured to couple to a container, the housing having a heating element configured to heat food within the container, and at least one air movement device configured to draw air into the housing and direct the air out of the bottom surface around an exterior of at least a portion of a perimeter of the container to cool an external surface of the container.

27. The cooking system of claim 26, wherein the housing further comprises an air intake provided at a top of the housing, wherein the at least one air movement device is configured to draw air into the housing, via the air intake.

28. The cooking system of claim 26, wherein the housing further comprises an air outlet provided around at least a portion of a perimeter of the bottom surface, wherein the perimeter of the container is provided radially inward of the air outlet when the container is coupled to the bottom surface, and wherein the at least one air movement device is configured to direct the air out of the air outlet to cool the external surface of the container.

29. The cooking system of claim 28, wherein the air outlet is provided above at least one handle provided on the external surface of the container such that the air directed out of the air outlet is configured to cool the at least one handle.

30. The cooking system of claim 26, wherein the housing further comprises at least one electronic component positioned therein configured to provide power to the cooking system, wherein the air drawn into the housing by the at least one air movement device is configured to provide convective cooling to the at least one electronic component prior to being directed out of the bottom surface.

31. The cooking system of claim 30, wherein the at least one air movement device comprises:
a first fan configured to draw a first flow of air into the housing and direct the first flow of air over the heating element and into the container to heat food within the container; and
a second fan configured to draw a second flow of air into the housing and direct the second flow of air out of the bottom surface around the exterior of at least the portion of the perimeter of the container.

32. The cooking system of claim 31, wherein the housing further comprises a first portion extending upward from the bottom surface to a partition, and a second portion extending upward from the partition to a top of the housing, wherein the first fan is provided in the first portion, and wherein the at least one electronic component and the second fan are provided in the second portion.

33. The cooking system of claim 32, wherein the housing further comprises a first air intake extending from the top of the housing to a position above the first fan within the first portion, and a second air intake extending from the top of the housing into the second portion, wherein the second fan is configured to draw air into the housing, via the second air intake, and direct the air over the at least one electronic component and out of the bottom surface around the exterior of at least the portion of the perimeter of the container.

34. The cooking system of claim 33, wherein the first fan is configured to draw air into the housing, via the first air intake, and direct the air over the heating element and into a volume of the container.

35. A cooking system, comprising:
a platform configured to be positioned on a countertop; and
a housing coupled to the platform such that a bottom surface of the housing is suspended over the countertop, wherein the bottom surface includes a seal assembly configured to couple to at least one of a first container of a second container, a heating element configured to heat food within at least one of the first container of the second container, at least one air movement device configured to draw air into the housing and direct the air out of the bottom surface, radially outside of the seal assembly, around an exterior of at least a portion of a perimeter of at least one of the first container of the second container,
wherein the seal assembly further comprises a first seal configured to selectively couple to the first container, a second seal configured to selectively couple to the second container, a first switch corresponding to the first seal, a second switch corresponding to the second seal, and a third switch corresponding to the seal assembly, wherein only the first and third switches are configured to actuate when the first container is selectively coupled to the first seal, and only the second and third switches are configured to actuate when the second container is selectively coupled to the second seal.

36. The cooking system of claim 35, wherein the housing further comprises a first portion extending upward from the bottom surface to a partition, and a second portion extending upward from the partition to the top of the housing, wherein the air movement device is provided in the second portion.

37. The cooking system of claim 36, further comprising a second air movement device provided in the first portion, wherein the second air movement device is configured to draw air into the housing and direct the air over the heating element and into a volume of the first container or the second container.

38. The cooking system of claim 36, wherein the housing further comprises an air exhaust extending from the first portion to the top of the housing, bypassing the second portion, wherein the air exhaust is configured to draw air out of the first portion as the air intake brings air into the housing.
